(19) United States
(12) Patent Application Publication
(10) Pub. No.: US 2024/0340995 A1
(43) Pub. Date: Oct. 10, 2024

(54) Communicating early and non-early data between a user device and a core network

(71) Applicant: GOOGLE LLC, Mountain View, CA (US)

(72) Inventor: Chih-Hsiang Wu, Taoyuan City (TW)

(21) Appl. No.: 18/681,507

(22) PCT Filed: Aug. 5, 2022
(86) PCT No.: PCT/US22/39506

§ 371 Date: Feb. 5, 2024

Related U.S. Application Data
(60) Provisional application No. 63/229,647, filed on Aug. 5, 2021.

(51) Int. Cl. H04W 76/27; H04L 5/00; H04W 68/02

(52) U.S. Cl. CPC H04W 76/27; H04L 5/0094; H04W 68/02

(57) ABSTRACT

A base station or a UE perform methods for communicating early and/or non-early data A method performed by a base station may include determining (1302) that first data is available for communicating between the CN and the UE operating in an inactive state of a protocol for controlling radio resources. The method may further include determining (1304) whether the UE is performing early-data communication of second data, and selecting (1306) a procedure for communicating the first data based at least in part on whether the UE is performing early-data communication.

### FIELD OF THE DISCLOSURE

This disclosure relates generally to wireless communications and, more particularly, to communication of uplink and/or downlink data at a user equipment (UE) when the UE operates in an inactive state, idle state, or connected state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state due to Radio Access Network (RAN)-level base station coordination and RAN-paging procedures. In some cases, the UE in the RRC_IDLE or RRC_INACTIVE state has only one, relatively small packet to transmit. In these cases, the UE in the RRC_IDLE or RRC_INACTIVE state can perform an early data transmission without transitioning to the RRC_CONNECTED state, e.g., by using techniques as specified in 3GPP specification 36.300 v16.4.0 section 7.3a-7.3d.

However, implementing data transmission techniques while the UE is in an inactive state (e.g., RRC_INACTIVE) or an idle state (e.g., RRC_IDLE) presents several challenges. For example, a 5G NR radio access network (i.e., the NG-RAN) can include distributed base stations, where each distributed base station includes a central unit (CU) and at least one distributed unit (DU). It is not clear how a distributed base station manages non-early data communication for a UE while performing early data communication with that UE operating in an inactive or an idle state.

Further, during early data communication, a base station or a UE can detect new data that does not qualify for early data communication. It is not clear how the base station and/or the UE should manage interactions between early and non-early data.

### SUMMARY

A base station and/or a UE determine whether the UE should transition from an inactive state to a connected state of a protocol for controlling radio resources (e.g., RRC) based on factors such as whether new downlink or uplink data qualifies for early data communication, whether the UE currently is performing early data communication, whether a radio bearer is configured for early data communication or non-early data communication, or whether a message between the UE and the RAN travelled on a CCCH channel or a DCCH channel. For example, the base station can select an appropriate procedure such as paging a UE, transmitting downlink data without paging, transitioning the UE to the connected state, etc. in view of the current state of early-data communication. When the base station is implemented in a distributed manner, the CU can determine whether the UE should modify a UE context or a set up a new context based on similar factors.

One example embodiment is a method implemented in a base station operating in a RAN, for facilitating data communication between a UE and a core network (CN). The method includes: determining that first data is available for communicating between the CN and the UE operating in an inactive state of a protocol for controlling radio resources; determining whether the UE is performing early-data communication of second data; and selecting a procedure for communicating the first data based at least in part on whether the UE is performing early-data communication.

Another example embodiment is a base station including processing hardware and a transceiver, configured to implement the method above.

A further example embodiment is a method implemented in a UE for communicating data with a CN via a RAN. The method includes: performing, in an inactive state of a protocol associated with controlling radio resources, an early data communication with the CN; determining, while the UE continues to operate in the inactive state, whether non-early data is available for communicating between the UE and the CN; and when the non-early data is available, transitioning to a connected state of the protocol.

Yet another example embodiment is a UE including processing hardware and a transceiver, configured to implement the method above.

### BRIEF DESCRIPTION OF THE DRAWINGS

FIG. 1A is a block diagram of an example system in which a base station and/or a user equipment (UE) can communicate early and/or non-early data according to various embodiments;

FIG. 1B is a block diagram of an example base station including a central unit (CU) and a distributed unit (DU) that can operate in the system of FIG. 1A;

FIG. 2A is a block diagram of an example protocol stack according to which the UE of FIGS. 1A-B can communicate with base stations;

FIG. 2B is a block diagram of an example protocol stack according to which the UE of FIGS. 1A-B can communicate with a distributed base station;

FIG. 3A illustrates an example scenario in which a UE determines to transmit non-early data to the CN while performing early-data communication, and initiates a procedure for transitioning to the connected state, which can be implemented in the system of FIG. 1A;

FIG. 3B illustrates an example scenario in which a base station determines to transmit non-early data to the UE while performing early-data communication with the UE, and the base station transmits at least some of the non-early data while the UE continues to operate in the inactive state;

FIG. 3C illustrates an example scenario in which a base station determines to transmit non-early data to the UE while performing early-data communication with the UE, and the base station transmits to the UE an indication of non-early downlink data;

FIG. 4A is a flow diagram of an example method in a central unit (CU) of a distributed base station, which includes triggering paging of a UE currently performing early-data communication, in order to transmit non-early DL data to the UE;

FIG. 4B is a flow diagram of a method generally similar to that of FIG. 4A, but with the CU instructing the UE to transition to the connected state to receive non-early DL data;

FIG. 4C is a flow diagram of an example method in a CU, which includes transmitting non-early DL data to the UE without instructing the UE to transition to the connected state, if the UE currently is performing early-data communication;

FIG. 4D is a flow diagram of an example method in a CU similar to that of FIG. 4C, except that the UE transmits a dedicated RRC message to request communication of non-early data;

FIG. 4E is a flow diagram of an example method in a CU, which includes transmitting to the UE a DL RRC message to indicate that non-early DL data is available;

FIG. 4F is a flow diagram of a method similar to that of FIG. 4E, but with the UE transmitting a dedicated RRC message to request communication of non-early data;

FIGS. 5A-F illustrate methods similar to those of FIGS. 4A-F, respectively, but implemented in a non-distributed base station;

FIG. 6 is a flow diagram of an example method in a CU for initiating early-data communication with a UE after receiving a request to resume a radio connection between the UE and the RAN;

FIG. 7A is a flow diagram of an example method in a CU for selecting a context modification procedure or a context setup procedure depending on whether the message from the UE was received on a common control channel (CCCH) or a dedicated control channel (DCCH);

FIG. 7B is a flow diagram of an example method in a CU for selecting a context modification procedure or a context setup procedure depending on whether the message from the CU is a request to resume a radio connection;

FIG. 8 is a flow diagram of an example method in a CU for determining whether a single DU or multiple DUs should page a UE depending on whether the UE currently is performing early-data communication;

FIG. 9A is a flow diagram of an example method in a UE for selecting a non-early data radio bearer for transmission to the connected state, after receiving a non-early DL data packet in the inactive state;

FIG. 9B is a flow diagram of an example method in a UE for selecting a non-early data radio bearer for transmission to the connected state, after receiving a DL RRC message in the inactive state;

FIG. 10 is a flow diagram of an example method in a UE for selecting a UL message for transitioning to the connected state, based at least in part on whether the UE currently is performing early-data communication;

FIG. 11 is a flow diagram of an example method in a UE for selecting a radio bearer for transmitting UL data based on whether the UE received a DL data packet while in a connected state or inactive state;

FIG. 12 is a flow diagram of an example method in a UE for selecting a radio bearer for transmitting UL data in an inactive state, depending on the radio bearer with which the UL data is associated;

FIG. 13 is a flow diagram of an example method for facilitating data communication between a UE and a CN, which can be implemented in a base station of FIG. 1A;

FIG. 14 is a flow diagram of an example method for communicating data with a CN, which can be implemented in a UE of FIG. 1A; and

FIG. 15 is a flow diagram of an example method for transitioning between states of a protocol for controlling radio resources between the UE and a RAN, which can be implemented in a UE of FIG. 1A.

### DETAILED DESCRIPTION OF THE DRAWINGS

As discussed in more detail below, a user equipment (UE) and/or a network node of a radio access network (RAN) can manage early data communication and transitioning a UE between states of a protocol for controlling radio resources between the UE and the RAN. As used in this disclosure, early data communication can refer to early data transmission (EDT) from the perspective of the network (i.e., EDT in the downlink direction), or EDT from the perspective of the UE (i.e., EDT in the uplink direction).

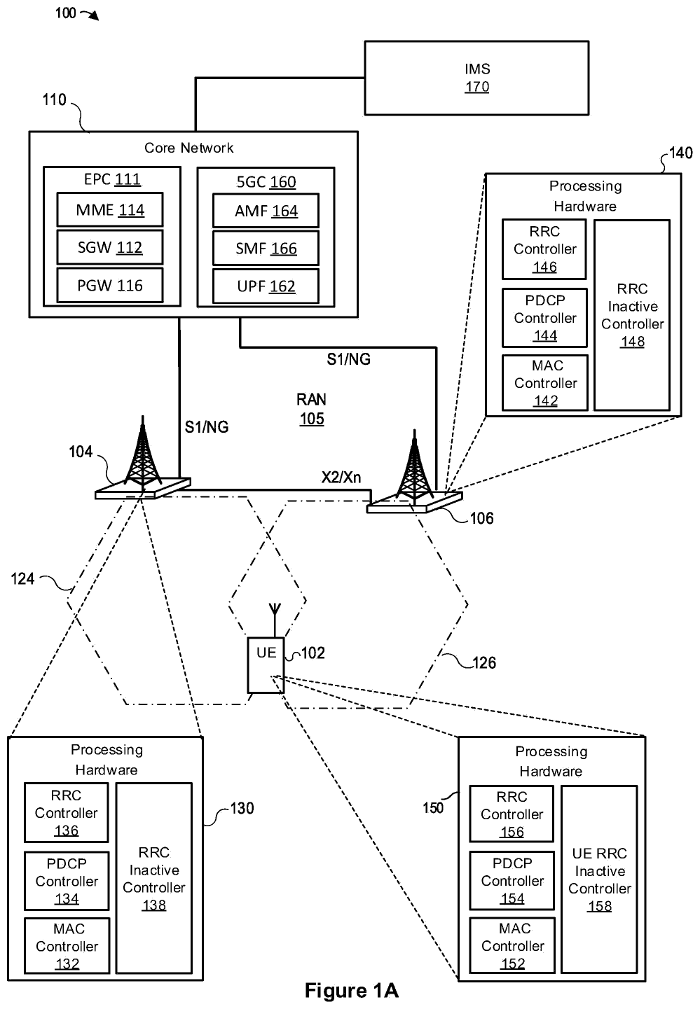

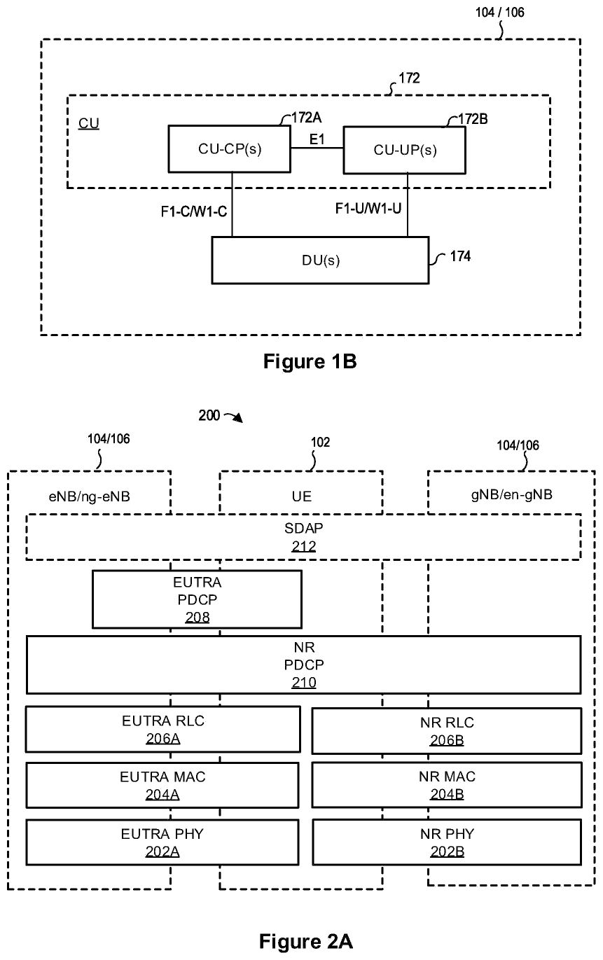

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-CNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

The CN 110 may also communicatively connect the UE 102 to an Internet Protocol (IP) Multimedia Subsystem (IMS) network 170, via the RAN 105. The IMS network 170 can provide to the UE 102 various IMS services, such as IMS short messages, IMS unstructured supplementary service data (USSD), IMS value added service data, IMS supplementary service data, IMS voice calls, and IMS video calls. To this end, an entity (e.g., a server or a group of servers) operating in the IMS network 170 supports packet exchange with the UE. The packets can convey signaling (such as session initiation protocol (SIP) messages, IP messages, or other suitable messages) as well as data (“or media”) such as voice or video.

As discussed in detail below, the UE 102 and/or the RAN 105 may utilize the methods described below when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol.

As used in this disclosure, the term “data” or “data packet” refers to signaling. control-plane information at a protocol layer of controlling radio resources (e.g., RRC); controlling mobility management (MM); controlling session management (SM); or non-signaling, non-control-plane information at protocol layers above the layer of the protocol for controlling radio resources (e.g., RRC), above the layer of the protocol for controlling mobility management (MM), above the layer of the protocol for controlling session management (SM), or above the layer of the protocol for controlling quality of service (QOS) flows (e.g., service data adaptation protocol (SDAP)). The data to which the UE and/or the RAN applies the methods described below can include, for example, Internet of Things (IoT) data, ethernet traffic data, internet traffic data, or a short message service (SMS) message. Further, as discussed below, the UE 102 in some implementations applies these methods only if the size of the data is below a certain threshold value.

In the example scenarios discussed below, the UE 102 transitions to the RRC_INACTIVE or RRC_IDLE state, selects a cell of the base station 104, and exchanges data with the base station 104, either via the base station 106 or with the base station 104 directly, without transitioning to RRC_CONNECTED state. As a more specific example, after the UE 102 determines that data is available for uplink transmission in the RRC_INACTIVE or RRC_IDLE state, the UE 102 can apply one or more security functions to an uplink (UL) data packet, generate a first UL protocol data unit (PDU) including the security-protected packet, include a UL RRC message along with the first UL PDU in a second UL PDU, and transmit the second UL PDU to the RAN 105. The UE 102 includes a UE identity/identifier (ID) for the UE 102 in the UL RRC message. The RAN 105 can identify the UE 102 based on the UE ID. In some implementations, the UE ID can be an inactive Radio Network Temporary Identifier (I-RNTI), a resume ID, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105 while in the RRC_INACTIVE or RRC_IDLE state.

In some implementations, the data is an uplink (UL) service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In further implementations, the UE 102 may not include a UL RRC message in the UL MAC PDU. In this case, the UE 102 may not include a UE ID of the UE 102 in the UL MAC PDU not including a UL RRC message. In yet further implementations, the UE 102 can include the UL PDCP PDU in a UL radio link control (RLC) PDU and then include the UL RLC PDU in the UL MAC PDU. In the case of including the UL RRC message in the UL MAC PDU, the UE 102 in some implementations generates an RRC MAC-I and includes the RRC MAC-I in the UL RRC message. For example, the RRC MAC-I is a resumeMAC-I field, as specified in 3GPP specification 38.331. In further implementations, the UE can obtain the RRC MAC-I from the UL RRC message with an integrity key (e.g., KRRCint key), an integrity protection algorithm, and other parameters COUNT (e.g., 32-bit, 64-bit or 128-bit value), BEARER (e.g., 5-bit value) and DIRECTION (e.g., 1-bit value).

In further implementations, the data is a UL service data unit (SDU) of the NAS. The UE 102 applies the security function to the SDU and includes the secured SDU in a first UL PDU such as a NAS PDU, which can be associated with the NAS layer. For example, the NAS layer can be an MM sublayer or SM sublayer of 5G, Evolved Packet System (EPS), or 6G. Then the UE 102 can include the UL NAS PDU in a second UL PDU such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may not include an RRC MAC-I in the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102. Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an encryption and/or decryption key). If the security-protected packet is an integrity-protected packet, the integrity-protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. However, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an encryption and/or decryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 currently operating in the RRC_INACTIVE or RRC_IDLE state, the base station 104 can apply at least one security function to the data to generate a security-protected packet, generate a first DL PDU including the security-protected packet, and the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting the integrity of the data and encrypt the data along with the MAC-I to generate an encrypted packet and an encrypted MAC-I. The base station 104 in some implementations generates a first DL PDU, such as a DL PDCP PDU, using the security-protected packet, includes the first DL PDU in a second DL PDU associated with the MAC layer for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC

PDU and transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU), including the DL RLC PDU, and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response that the base station transmits in a random access procedure with the UE 102 before transmitting the DCI and scrambled CRC. In further implementations, the base station may assign the ID of the UE 102 to the UE 102 in an RRC message (e.g., RRC release message or an RRC reconfiguration message) that the base station transmits to the UE 102 before transmitting the DCI and scrambled CRC, e.g., while the UE 102 was in the RRC_CONNECTED state.

The UE 102 operating in the RRC_INACTIVE or RRC_IDLE state can receive the DCI and scrambled CRC on the PDCCH. Then the UE 102 confirms that a physical downlink shared channel (PDSCH), including the second DL PDU, is addressed to the UE 102 according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 can then verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction, in some scenarios, and receive UL PDCP PDUs in accordance with which the base station 104 can receive data in the uplink direction, in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 104 also includes hardware for wirelessly communicating with other devices, including the UE 102, such as an antenna, transceiver, emitter, and/or receiver. The base station 106 can include generally similar components. In particular, components 140, 142, 144, 146, and 148 of the base station 106 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to, in some scenarios, transmit DL PDCP PDUs in accordance with which the base station 106 can transmit data in the downlink direction, and, in further scenarios, receive UL PDCP PDUs in accordance with which the base station 106 can receive data in the uplink direction. The processing hardware further can include an RRC controller 156 to implement procedures and messaging at the RRC sublayer of the protocol communication stack. The UE 102 also includes hardware for wirelessly communicating with other devices, including the RAN 105, such as an antenna, transceiver, emitter, and/or receiver.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the El interface. The CU-CP 172A selects the appropriate CU-UP 172B for the requested services for the UE 102. In some implementations, a single CU-UP 172B can connect to multiple CU-CP 172A through the El interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

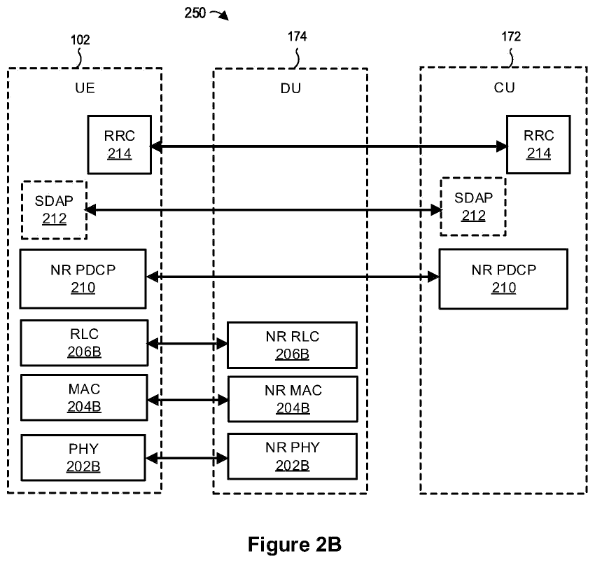

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

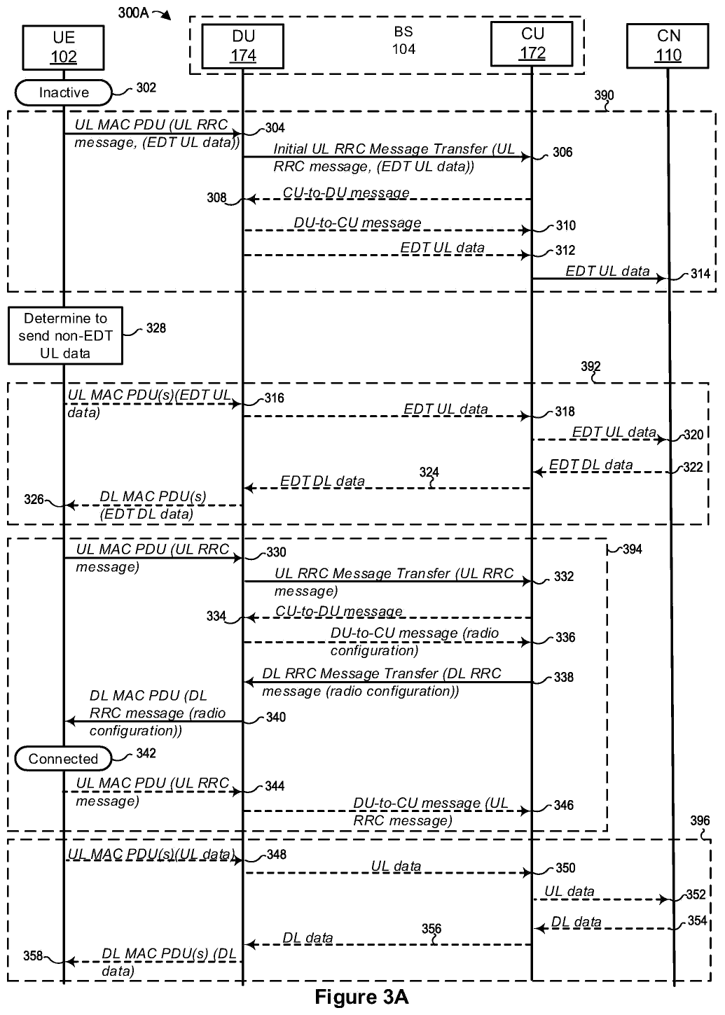

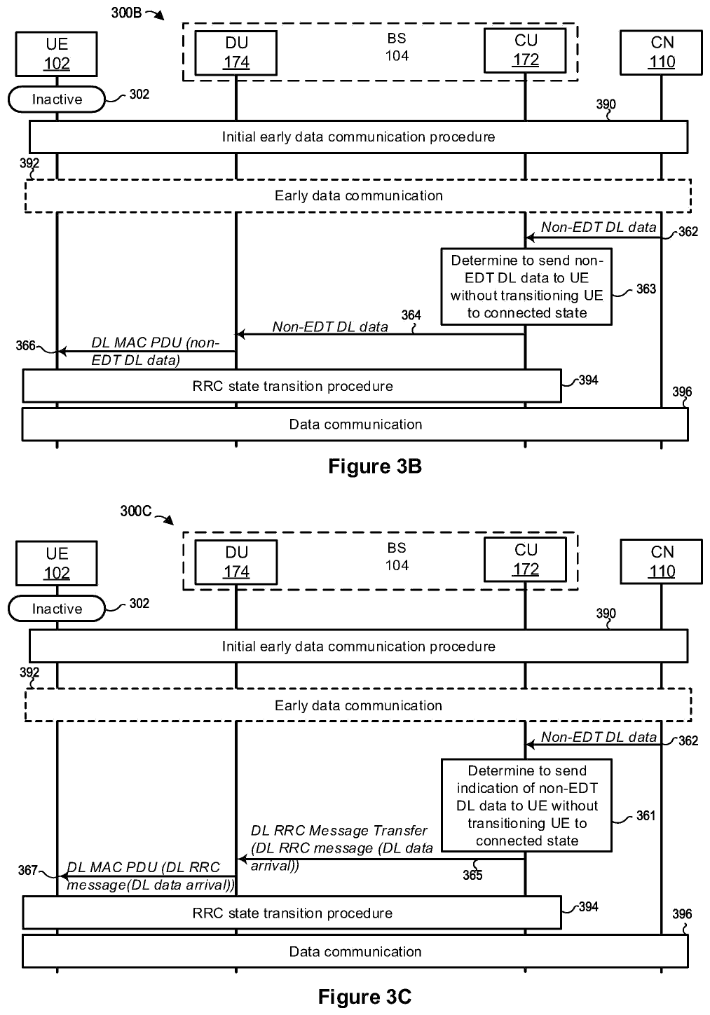

Next, several example scenarios that involve components of FIGS. 1A-1B and relate to managing pending data that is not eligible for EDT (“non-EDT data”) while a UE and a RAN are performing EDT are discussed with reference to FIGS. 3A-3C. More particularly, FIG. 3A illustrates a scenario in which a UE determines, while the UE performs EDT, to transmit non-EDT UL data to a CN via a RAN. FIGS. 3B-3C illustrate scenarios in which a RAN determines, while performing EDT with a UE, to transmit non-EDT DL data to the UE. Generally speaking, similar events in FIGS. 3A-3C are labeled with the same reference numbers. To simplify the following description, the “inactive state” can represent the RRC_INACTIVE or RRC_IDLE state, and the connected state can represent the RRC_CONNECTED state.

Referring first to FIG. 3A, in a scenario 300A, the UE 102 initially operates 302 in an inactive state with the base station 104 including a CU 172 and a DU 174. Before operating 302 in the inactive state, the UE 102 may operate in a connected state with the RAN 105 (e.g., the base station 104, base station 106, or another base station not shown in FIG. 1A). While operating in the connected state, the UE 102 communicates data with the RAN 105, e.g., via one or more radio bearers (RBs). The UE 102 in the connected state communicates control-plane (CP) data via one or more signaling RBs (SRBs). The UE 102 in the connected state communicates the user-plane (UP) data via one or more data RBs (DRBs).

The RAN 105 can determine that neither the RAN 105 nor the UE 102 has transmitted any data in the downlink direction or the uplink direction, respectively, during a (first) certain period. In response to the determination, the RAN 105 can transmit a first RRC release message (e.g., RRCRelease message or RRCConnectionRelease message) to the UE 102 to instruct the UE 102 to transition to the inactive state. The UE 102 transitions 302 to the inactive state upon receiving the first RRC release message. The RAN 105 can assign an I-RNTI or a resume ID to the UE 102 and include the assigned value in the first RRC release message. In some embodiments, after the UE 102 transitions 302 to the inactive state, the UE 102 may perform one or more RAN notification area (RNA) updates with the CU 172 via the DU 174 without state transitions.

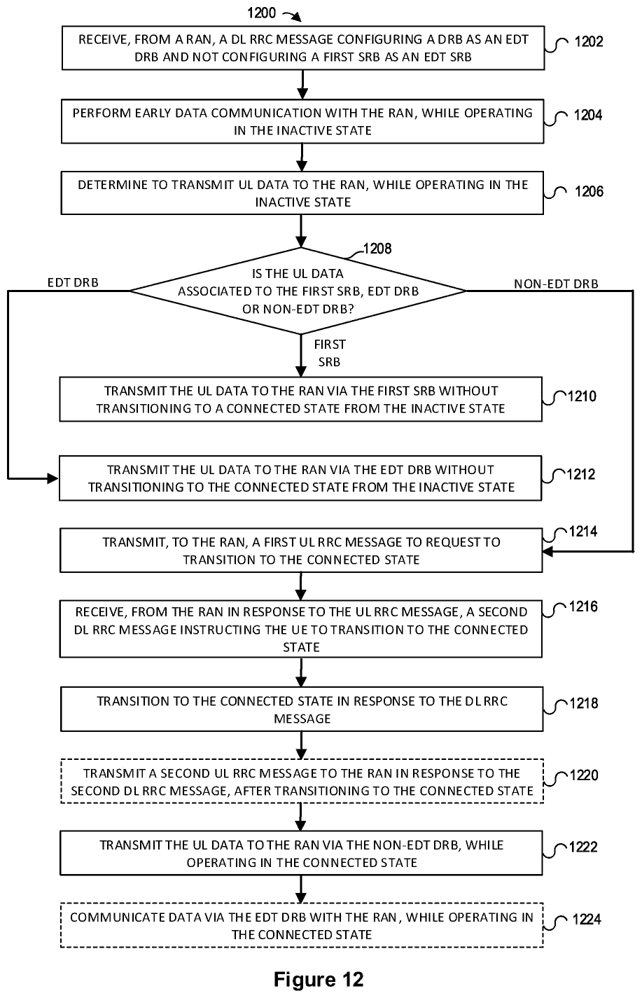

While the UE 102 operates in the connected state, or when causing the UE 102 to transition to the inactive state, the RAN 105 can configure the UE 102 with one or more RB(s). Each of the RB(s) may be suitable for, or configured for, EDT or non-EDT. Additional details are discussed in the paragraphs below, and with reference to FIG. 12.

With respect to SRBs, in some implementations, the first RRC release message transmitted by the RAN 105 instructs the UE 102 to transition 302 to the inactive state and indicates an SRB, of the one or more SRBs, as an early data transmission (EDT) RB (i.e., a first SRB suitable or configured for EDT). For example, the RAN 105 can include an EDT indication in the first RRC release message to indicate that a first SRB of the one or more SRBs is an EDT SRB. If the RAN 105 does not include an EDT indication for a second SRB in the first RRC release message, the second SRB is implicitly a non-EDT RB (i.e., the second SRB is unsuitable or not configured for EDT). Alternatively, the RAN 105 can include a non-EDT indication in the first RRC release message to indicate explicitly that the second SRB is a non-EDT SRB.

In alternative implementations, instead of using the first RRC release message to indicate EDT and non-EDT RBs, the RAN 105 can indicate that an SRB of the one or more SRBs is an EDT SRB in a DL RRC message (e.g., RRC reconfiguration message) that the RAN 105 sends while the UE 102 operates in the connected state. For example, the RAN 105 can include an EDT indication in the DL RRC message to indicate that a first SRB of the one or more SRBs is an EDT SRB. If the RAN 105 does not include an EDT indication for a second SRB in the one or more SRBs in the DL RRC message, the second SRB is implicitly a non-EDT SRB (i.e., the second SRB is unsuitable or not configured for EDT). Alternatively, the RAN 105 can include a non-EDT indication in the DL RRC message to indicate explicitly that the second SRB is a non-EDT SRB. In yet alternative implementations, particular SRB(s) (e.g., SRB0, SRB1 and/or SRB2) of the one or more SRBs can be EDT SRB(s) by default, even though the RAN 105 does not indicate the particular SRB(s) in the one or more SRBs as EDT SRB(s). In such implementations, the UE 102 identifies the particular SRB(s) as EDT SRB(s), even though the UE 102 does not receive from the RAN 105 indication(s) that the particular SRB(s) are EDT SRB(s). In such implementations, the RAN 105 also determines that the particular SRB(s) are EDT SRB(s), even though the RAN 105 does not transmit to the UE 102 indication(s) that the particular SRB(s) are EDT SRB(s).

The RAN 105 can utilize the methods described above with reference to SRBs in order to indicate whether DRBs are EDT DRBs or non-EDT DRBs. For example, the RAN 105 can indicate in the first RRC release message or in a DL RRC message that a DRB of the one or more DRBs is an EDT DRB or a non-EDT DRB, in the manner described above.

Turning back to the scenario 300A, after transitioning 302 to the inactive state, the UE 102 initiates EDT to transmit EDT UL data or receive EDT DL data. The UE 102 can initiate EDT in order to transmit at least one UL data packet to the base station 104 (i.e., mobile originating (MO) EDT. In such cases, the UE 102 detects an UL data packet for transmission to the base station 104, and initiates EDT to transmit the UL data packet if the UL data packet is suitable for EDT (e.g., if the UL data packet size is below a maximum size for EDT, or if the UL data meets other criteria, as described below).

In other cases (not shown), the UE 102 initiates EDT to receive at least one DL data packet from the base station 104 (i.e., mobile terminating (MT) EDT, which can also be described as early data reception from the perspective of the UE 102). In such cases, the CU 172 detects DL data for the UE 102 that is suitable for transmission using EDT and, in response, transmits a CU-to-DU message to the DU 174 in order to page the UE 102. The DU transmits a Paging message, which may include a UE ID of the UE 102 and an EDT indication, to the UE 102. The UE ID may be the I-RNTI, the resume ID, or a NAS ID (e.g., S-TMSI or 5G-S-TMSI, or a specific ID for MT EDT). The EDT indication in the Paging message notifies the UE 102 to initiate EDT in order to receive the DL data without transitioning to the connected state. The UE 102 can then initiate EDT in response to receiving the Paging message (i.e., in response to receiving the UE ID and the EDT indication).

The (UL/DL) data in some example scenarios is an Internet Protocol (IP) packet, an Ethernet packet, or an application packet. In other scenarios, the data is a PDU (e.g., SDAP PDU, RRC PDU, PDCP PDU, RLC PDU or MAC PDU) that includes an RRC message, an NAS message, an IP packet, an Ethernet packet, or an application packet. Still further, the data in some scenarios can be an RRC PDU including an NAS PDU, such that the NAS PDU includes an IP packet, an Ethernet packet, or an application packet. In some implementations, the UE 102 can determine whether the UL data qualifies for transmission in the inactive state in view of one or more of factors such as whether the data is an IMS packet, whether the data is associated with a radio bearer (e.g., DRB or SRB) not suitable or configured for early data transmission, whether the data is a NAS message for initiating a particular NAS procedure, the size of the data, etc. In some implementations, the CU 172 can determine whether the DL data qualifies for transmission in the inactive state in view of one or more of factors such as whether the data is an IMS packet, whether the data is associated with a radio bearer (e.g., DRB or SRB) not suitable or configured for early data transmission, whether the data is an NAS message for initiating a particular NAS procedure, the size of the data, etc. If the UL data qualifies for transmission in the inactive state, the UL data is hereinafter referred to as EDT UL data. For example, the UL data is associated to an EDT RB (e.g., EDT SRB or EDT DRB). Otherwise, the UL data is hereinafter referred to as non-EDT UL data. For example, the UL data is associated to non-EDT RB (e.g., non-EDT SRB or non-EDT DRB) or is not associated to an EDT RB (e.g., EDT SRB or EDT DRB). If the DL data qualifies for transmission in the inactive state, the DL data is hereinafter referred to as EDT DL data. For example, the DL data is associated to an EDT RB (e.g., EDT SRB or EDT DRB). Otherwise, the DL data is hereinafter referred to as non-EDT DL data. For example, the DL data is associated to non-EDT RB (e.g., non-EDT SRB or non-EDT DRB) or is not associated to an EDT RB (e.g., EDT SRB or EDT DRB).

In response to or after initiating EDT, the UE 102 generates an initial UL MAC PDU, which includes a first UL RRC message and transmits 304 the initial UL MAC PDU to the DU 174 on the cell 124. The DU 174 retrieves the first UL RRC message from the initial UL MAC PDU, generates an Initial UL RRC Message Transfer message including the first UL RRC message, and sends 306 the Initial UL RRC Message Transfer message to the CU 172.

In scenarios in which the UE 102 initiates EDT to transmit EDT UL data, such as the scenario 300A, the UE 102 includes EDT UL data (e.g., a data packet) in the initial UL MAC PDU that the UE 102 transmits 304. In scenarios in which the UE 102 initiates EDT to receive EDT DL data, the UE 102 does not include an UL data packet in the UL MAC PDU that the UE 102 transmits 304. In such scenarios, the UE 102 can include an EDT indication in the initial UL MAC PDU or the first UL RRC message to indicate to the base station 104 that the UE 102 is initiating EDT to receive EDT DL data.

In some implementations, the UE 102 in the inactive state performs a random access procedure with the DU 174 to transmit 304 the UL MAC PDU. For example, the random access procedure can be a four-step random access procedure or a two-step random access procedure. In the case of the four-step random access procedure, the UE 102 transmits a random access preamble to the base station 104 and, in response, the base station 104 transmits to the UE 102 a random access response (RAR) including an uplink grant, and the UE 102 transmits 304 the UL MAC PDU in accordance with the uplink grant. The DU 174 receives 304 the UL MAC PDU in accordance with the uplink grant in the RAR. In the case of the two-step random access procedure, the UE 102 transmits 304 to the DU 174 a message A including a random access preamble and the UL MAC PDU in accordance with two-step random access configuration parameters. The UE 102 receives the two-step random access configuration parameters in system information broadcast by the DU 174 on the cell 124 before transmitting 304 the UL MAC PDU. The DU 174 receives 304 the UL MAC PDU in accordance with the two-step random access configuration parameters.

In further implementations, the UE 102 can transmit 304 the UL MAC PDU on radio resources configured in a preconfigured uplink resources (PUR) configuration or a configured grant (CG) configuration. The CU 172 can obtain the PUR configuration or the CG configuration from the DU 174 and include the PUR configuration or CG configuration in the first RRC release message. Thus, the DU 174 receives 304 the UL MAC PDU on the radio resources. In such implementations, the UE 102 can transmit 316 and/or 330 subsequent UL MAC PDU(s), discussed below, on radio resources configured in the PUR configuration or the CG configuration. In cases where the first RRC release message includes other PUR configuration(s) or CG configuration(s), the UE 102 can transmit 316 and/or 330 the UL MAC PDU(s) on radio resources configured in the other PUR configuration(s) or CG configuration(s).

If the UE 102 includes EDT UL data in the initial UL MAC PDU, the DU 174 retrieves the EDT UL data from the initial UL MAC PDU. In such cases, the DU 174 can include the EDT UL data in the Initial UL RRC Message Transfer message. Alternatively, the DU 174 can send 312 the EDT UL data to the CU 172 separately, via a user-plane (UP) connection as described below. After receiving 306 the Initial UL RRC Message Transfer message, the CU 172 in some implementations sends 308 a first CU-to-DU message to the DU 174 to establish a UE Context of the UE 102 at the DU 174 and/or a UP connection between the CU 172 and DU 174 (e.g., F1-U tunnel or W1-tunnel) for receiving the EDT UL data and/or subsequent EDT UL data (e.g., subsequent EDT UL data 316, 318, 320 in subsequent early data communication 392). In response, the DU 174 can send 310 a first DU-to-CU message to the CU 172. In some implementations, the first CU-to-DU message and the first DU-to-CU message can be a UE Context Setup Request message and a UE Context Setup Response message, respectively.

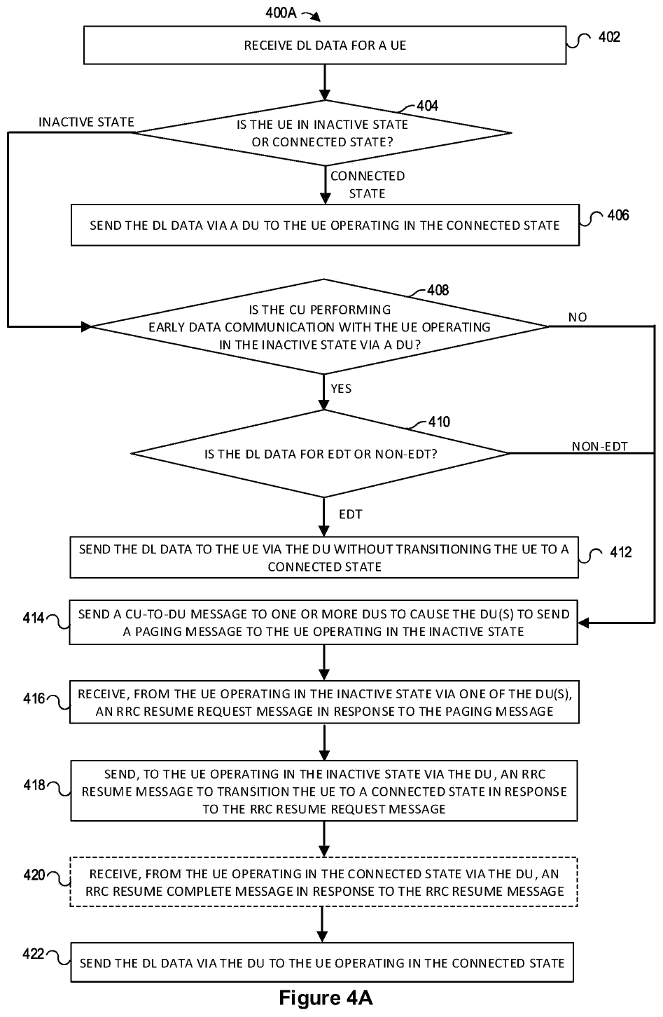

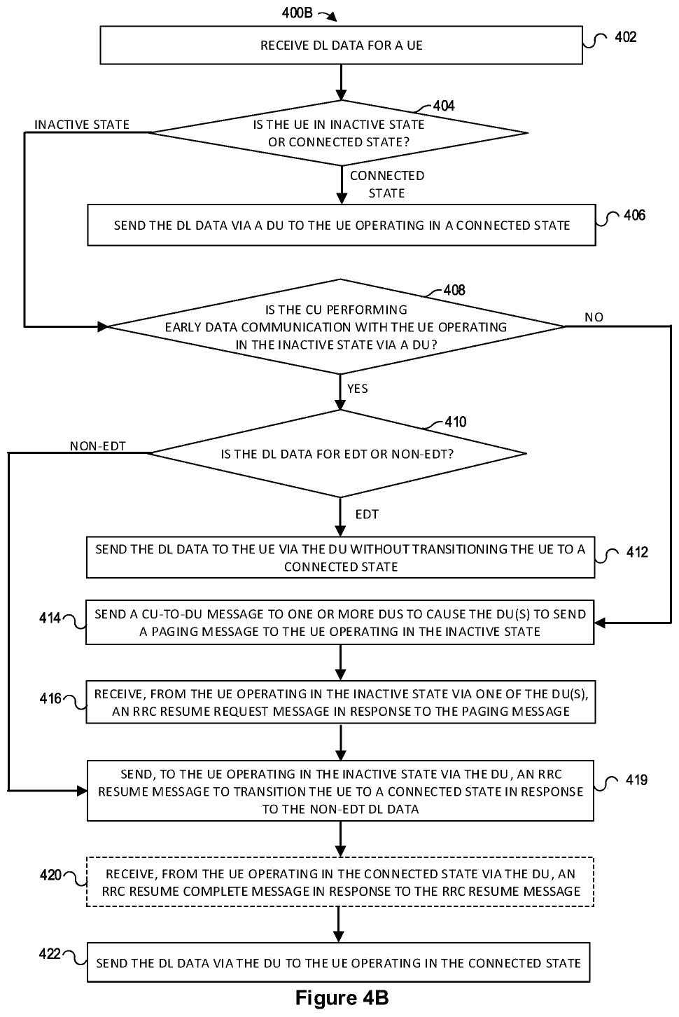

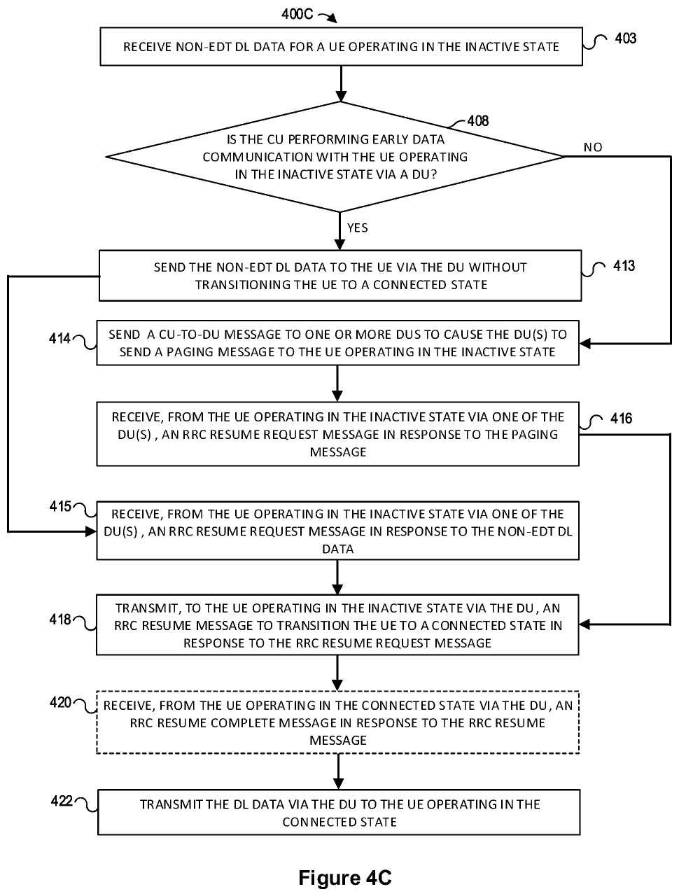

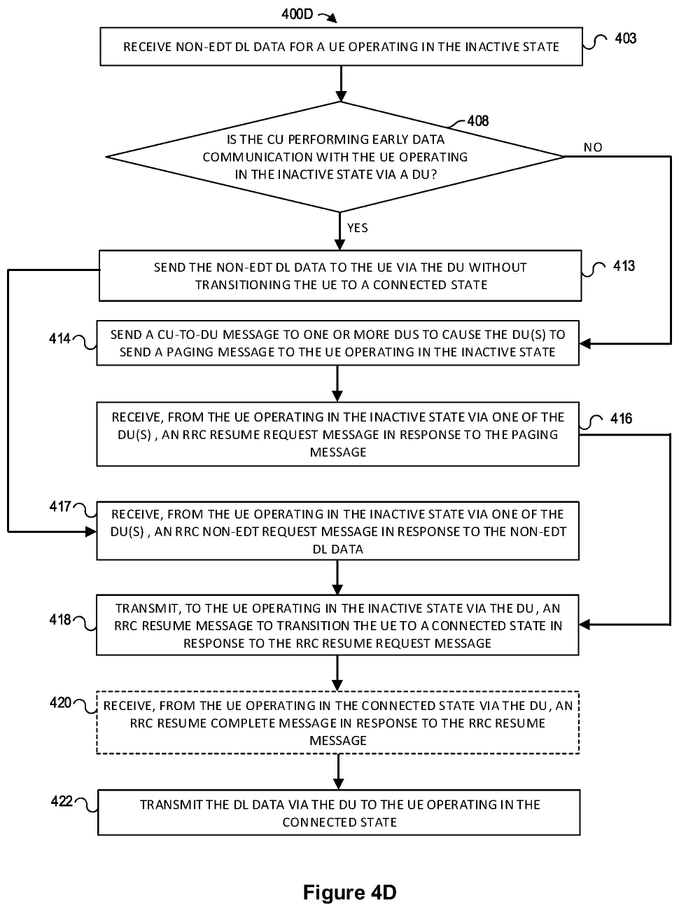

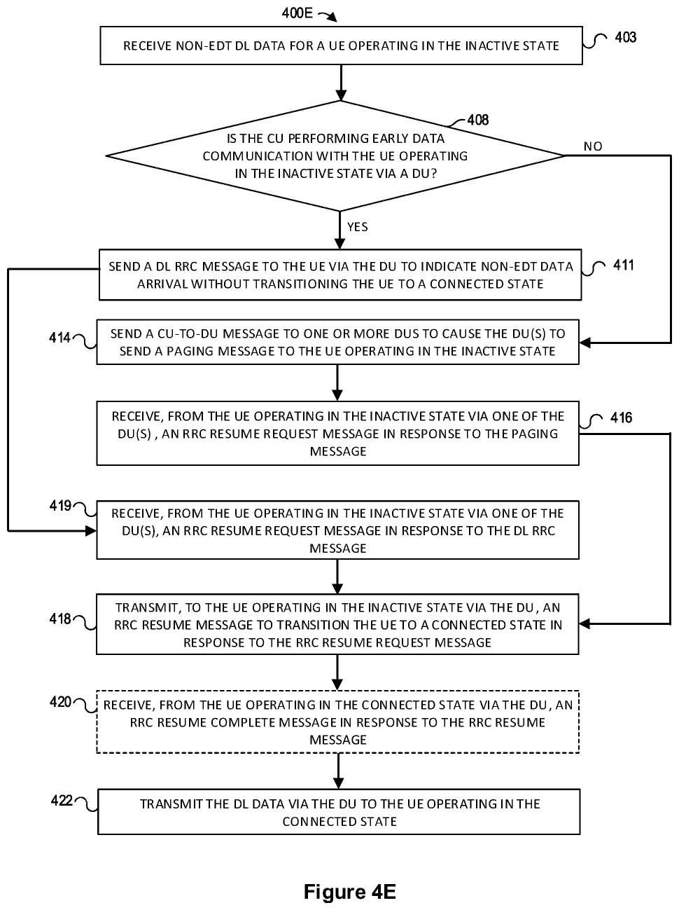

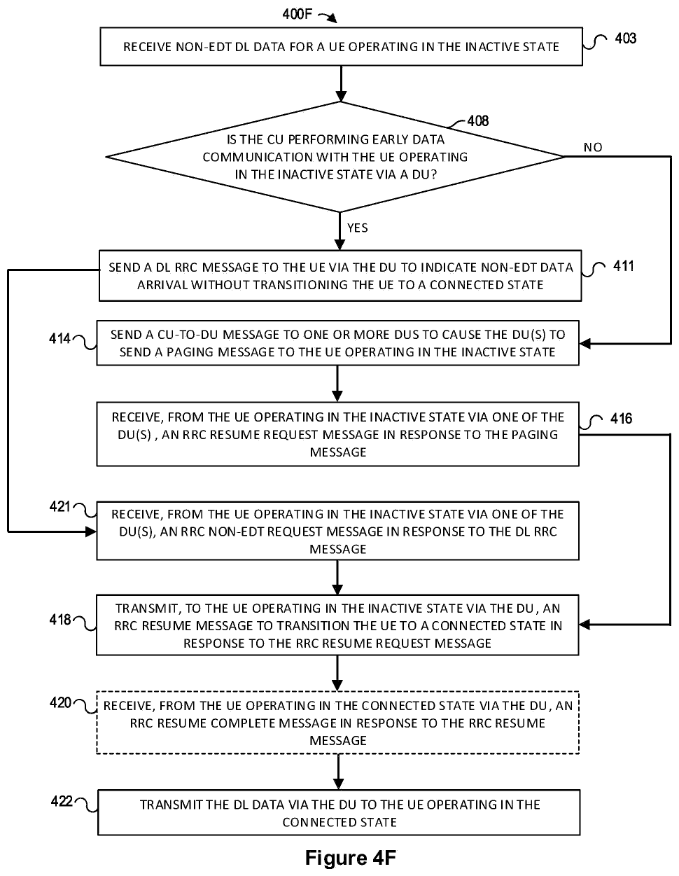

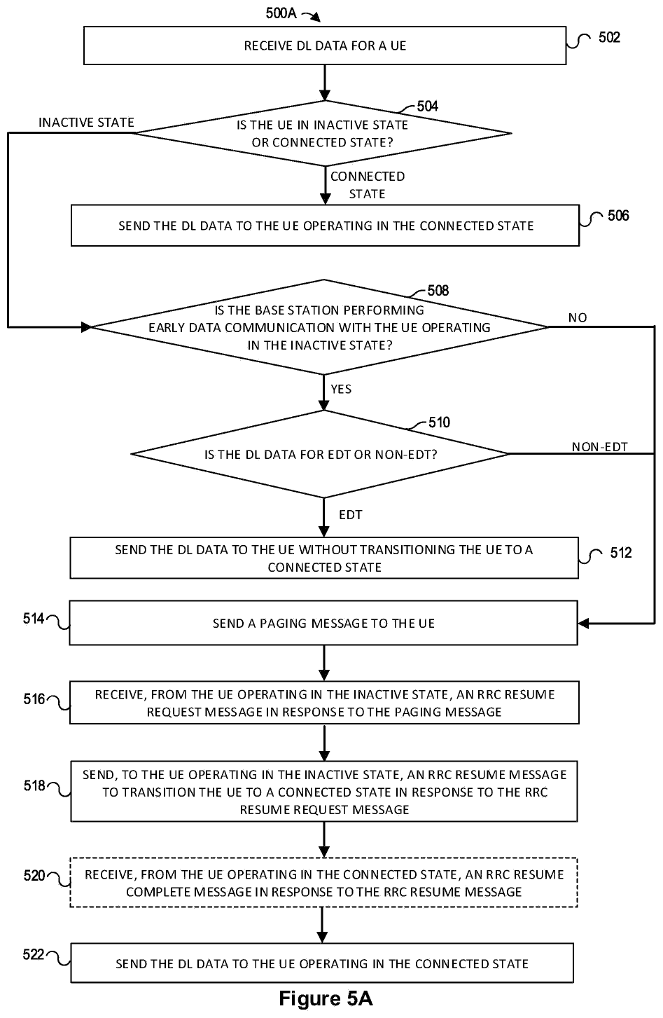

In some implementations, the first UL RRC message is an (existing) RRC resume request message (e.g., an RRCResumeRequest message, an RRCResumeRequest] message, an RRCConnectionResumeRequest message, or an RRCConnectionResumeRequestl message). In other implementations, the first UL RRC message can be a new RRC resume request message, similar to the existing RRC resume request message. For example, the new RRC resume request message may be defined in future 3GPP standards documentation. The new RRC resume request message may be a format of an existing RRC resume request message. Such a new RRC resume request message is discussed with reference to FIG. 4D. In some implementations, the first UL RRC message can include an EDT indication, which can be a field or information element (IE) (e.g., resumeCause or ResumeCause). In some implementations, the first UL RRC message is a common control channel (CCCH) message.

After generating the Initial UL RRC Message Transfer message, the DU 174 sends 306 the Initial UL RRC Message Transfer message to the CU 172 via control plane (CP) interface (e.g., F1-C interface or W1-C interface). Alternatively, the DU 174 can send 306 to the CU 172 a DU-to-CU message including the UL RRC message and the EDT UL data. For example, the DU-to-CU message can be a new or existing F1AP message or W1AP message specified in 3GPP specification 38.473 or 37.473. Then, the CU 172 can retrieve the EDT UL data packet from the Initial UL RRC Message Transfer message or the DU-to-CU message and send 314 the EDT UL data to the CN 110 (e.g., SGW 112, UPF 162, MME 114, or AMF 164). In further embodiments, the DU 174 may send 312 the EDT UL data to the CU 172 via the UP connection (e.g., a UP interface) after transmitting 306 the Initial UL RRC Message Transfer message or receiving 308 the CU-to-DU message. Alternatively, the CU 172 can transmit the EDT UL data to an edge server instead of the CN 110. In some implementations, the edge server can operate within the RAN 105. The events 304, 306, 308, 310, 312, and 314 are collectively referred to in FIG. 3A as an initial early data communication 390.

After transmitting 304 the initial UL MAC PDU, the UE 102 in the inactive state can transmit 316 to the DU 174 one or more subsequent UL MAC PDU (UL MAC PDU(s)) each including (subsequent) EDT UL data (e.g., a data packet). The DU 174 retrieves the (subsequent) EDT UL data from the subsequent UL MAC PDU(s) and sends 318 the (subsequent) EDT UL data to the CU 172. The CU 172 sends 320 the (subsequent) EDT UL data to the CN 110 or edge server.

Before or after receiving 306 the Initial UL RRC Message Transfer message, the CU 172 can receive 322 EDT DL data (i.e., one or more data packets) from the CN 110 or the edge server, or can generate the EDT DL data (e.g., one or more RRC messages) by itself. The CU 172 sends 324 the EDT DL data packets to the DU 174. The DU 174 generates one or more DL MAC PDUs to include the EDT DL data and transmits 326 the one or more DL MAC PDUs to the UE 102. The events 316, 318, 320, 322, 324, and 326 are collectively referred to in FIG. 3A as an early data communication 392. The EDT UL data transmission (i.e., events 316, 318, 320) and DL EDT data transmission (i.e., events 322, 324 and 326) can occur in parallel or one after the other. The initial early data communication 390 and the early data communication 392 occur during the same EDT session.

After transmitting 304 the initial UL MAC PDU and before (as shown in FIG. 3A) or during the early data communication 392 (i.e., during the EDT session), the UE 102 in the inactive state determines 328 to send non-EDT UL data (e.g., because the UE 102 determines that non-EDT UL data is available to transmit to the RAN 105). Non-EDT UL data does not qualify for transmission using EDT, based one or more of the factors discussed above. For example, as noted above, non-EDT UL data may be associated to a non-EDT RB. In FIG. 3A, the UE 102 initiates a state transition to a connected state in response to determining 328 to transmit non-EDT UL data. FIG. 12, described below, also illustrates how the UE 102 can transmit non-EDT UL data detected while operating in the inactive state to the RAN 105.

In the scenario 300A, in response to determining 328 to send non-EDT UL data, the UE 102 sends 330 a second UL MAC PDU including a second UL RRC message to the DU 174, where the second UL RRC message indicates that the UE 102 has non-EDT UL data to transmit. The second UL RRC message may include a buffer status report (BSR) indicating a volume of the non-EDT UL data that the UE 102 has available to transmit.

If the UE 102 determines 328 to send the non-EDT UL data, but also has subsequent EDT UL data to transmit to the RAN 105, the UE 102 in some implementations can transmit 316 the subsequent EDT UL data to the DU 174 prior to transmitting 330 the second UL RRC message (i.e., early data communication 392 may occur after event 328 and before event 330, as shown in FIG. 3A). In other implementations, the UE 102 can transmit 330 the second UL RRC message, and transmit the subsequent EDT UL data to the RAN 105 after transitioning to the connected state. Further, in some cases, the UE 102 determines 328 to send non-EDT UL data after the early data communication 392, but before receiving an indication from the DU 174 to stop performing EDT (e.g., an RRC release message) (i.e., before the EDT session ends).

In any event, after receiving 330 the UL MAC PDU, the DU 174 retrieves the second UL RRC message from the second UL MAC PDU, generates an UL RRC Message

Transfer message including the second UL RRC message, and sends 332 the UL RRC Message Transfer message to the CU 172. After receiving 332 the UL RRC Message Transfer message, the CU 172 in some implementations sends 334 a second CU-to-DU message to the DU 174 to modify a UE Context of the UE 102 at the DU 174 and/or obtain a radio configuration from the DU 174. In response, the DU 174 can send 336 a second DU-to-CU message including a radio configuration to the CU 172. In some implementations, the second CU-to-DU message and the second DU-to-CU message can be a UE Context Modification Request message and a UE Context Modification Response message, respectively. In some implementations, the radio configuration can be a CellGroupConfig information element (IE).

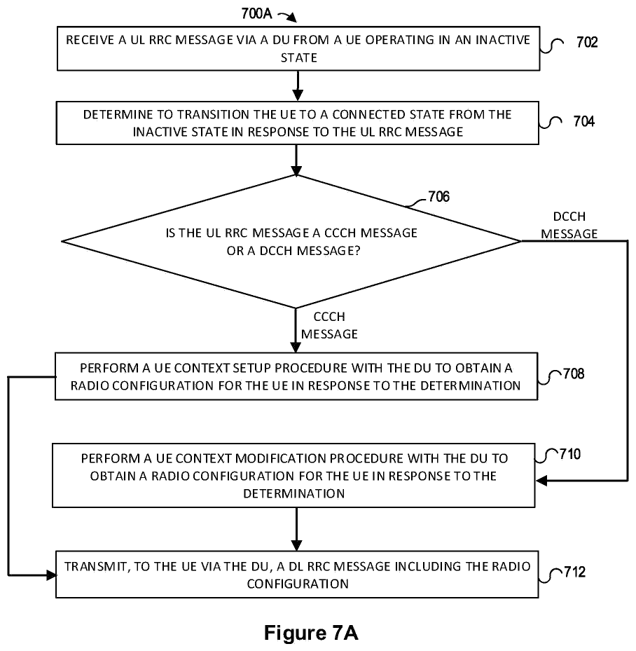

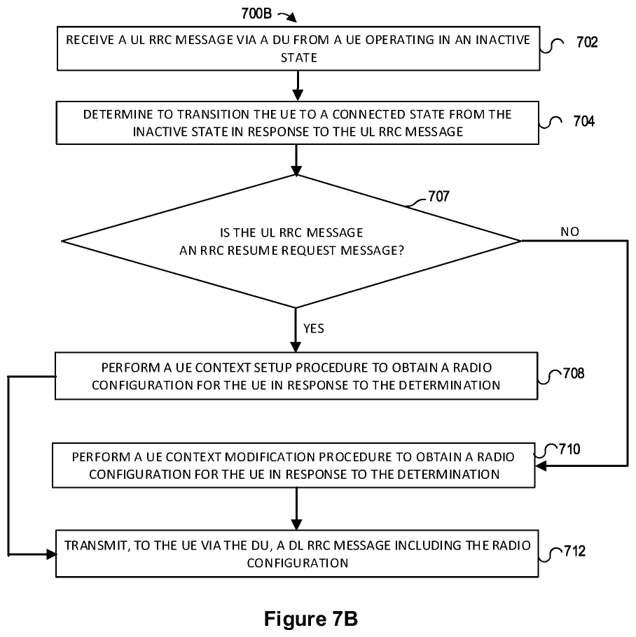

In some implementations, the second UL RRC message can be an RRC resume request message, similar to the first UL RRC message. In other implementations, the second UL RRC message can be a UE assistance information message (e.g., UEAssistanceInformation message). In some implementations, the second UL RRC message can be a dedicated control channel (DCCH) message. In other implementations, the second UL RRC message can be a CCCH message. The UE 102 does not include an EDT indication in the second UL RRC message. In the second UL RRC message, the UE 102 in some implementations can include a field or IE to indicate a cause for sending the second UL RRC message. For example, the field or IE can be a resumeCause or ResumeCause. In accordance with the cause, the CU 172 can determine how to configure the UE 102 or arrange radio resources for the UE 102. In some implementations, the UE 102 can include an RB identity of the non-EDT RB in the second UL RRC message. The CU 172 can determine that the UE 102 has data associated to the non-EDT RB to transmit in accordance with the RB identity. Based on whether the second UL RRC message is an RRC resume request message, and/or based on whether the UL RRC message is a CCCH message or a DCCH message, the CU 172 can determine a type of CU-to-DU message to transmit 334 (i.e., whether to transmit a UE Context Modification request or a UE Context Setup request), which will be discussed in further detail with reference to FIGS. 7A-7B.

After receiving 332 the UL RRC Message Transfer message (or receiving 336 the second DU-to-CU message), the CU 172 generates a DL RRC message including the radio configuration to transition the UE 102 to the connected state, generates a third CU-to-DU message including the DL RRC message, and transmits 338 the third CU-to-DU message (e.g., DL RRC Message Transfer message) to the DU 174. The DU 174 in turn retrieves the DL RRC message from the third CU-to-DU message, generates a DL MAC PDU including the DL RRC message, and transmits 340 the DL MAC PDU to the UE 102. In some implementations, the DL RRC message can be an RRC resume message (e.g., RRCResume message or RRCConnectionResume message). In other implementations, the DL RRC message can be an RRC reconfiguration message (e.g., RRCReconfiguration message or RRCConnectionReconfiguration message). In yet other implementations, the DL RRC message can be a new RRC message. The DL RRC message may reconfigure the EDT RB (e.g., an RB via which the UE communicates EDT data, such as at events 316, 326) to a non-EDT RB.

In response to the DL RRC message, the UE 102 transitions 342 to the connected state. In some implementations, the UE 102 transmits 344 a third UL RRC message (e.g., an RRC resume complete message, such as an RRCResumeComplete message) to the DU 174 to indicate that the UE 102 successfully transitioned 342 to the connected state. The DU 174 can send 346 a third DU-to-CU message including the third UL RRC message to the CU 172. In some implementations, the UE 102 can generate a third UL MAC PDU including the third UL RRC message and transmit 344 the third UL MAC PDU to the DU 174. The DU 174 retrieves the third UL RRC message from the third UL MAC PDU.

In some implementations, the UE 102 can determine that the EDT RB(s) become non-EDT RB(s) in response to or after transitioning to the connected state. In other implementations, the UE can determine that the EDT RB(s) are no longer subject to EDT in response to or after transitioning to the connected state. In other words, the UE 102 determines that the EDT indication(s) associated with the EDT RB(s) are no longer valid in response to or after transitioning to the connected state. The UE 102 can release the EDT indication(s) in response to or after transitioning to the connected state.

The events 330, 332, 334, 336, 338, 340, 342, 344, and 346 are collectively referred to in FIG. 3A as an RRC state transition procedure 394.

After transitioning 342 to the connected state or transmitting 344 the third UL MAC PDU, the UE 102 in the connected state can transmit 348 to the DU 174 a UL MAC PDU including UL data. The UL data includes the non-EDT UL data that the UE 102 detected previously at event 328, and may include other non-EDT UL data and/or EDT UL data (i.e., data that qualifies for transmission via EDT). The DU 174 retrieves the UL data from the UL MAC PDU and sends 350 the UL data to the CU 172. The CU 172 sends 352 the non-EDT UL data to the CN 110 or edge server. Furthermore, after transmitting the third UL MAC PDU, the UE 102 in the connected state can transmit to the DU 174 additional UL MAC PDU(s) including UL data regardless of whether the data qualifies for EDT. The DU 174 retrieves the UL data from the additional UL MAC PDU(s) and sends the UL data to the CU 172. In each additional UL MAC PDU, the UE 102 can include only UL data that qualifies for EDT, only UL data that does not qualify for EDT, or a combination of UL data that qualifies for EDT and UL data that does not qualify for EDT.

After transmitting 338 the third CU-to-DU message or receiving 346 the third DU-to-CU message, the CU 172 can receive 354 DL data (i.e., one or more data packets) from the CN 110 or the edge server. The DL data can include non-EDT data and/or EDT data. The CU 172 sends 356 the DL data to the DU 174. The DU 174 generates one or more DL MAC PDUs to include the DL data and transmits 358 the one or more DL MAC PDUs to the UE 102. The events 348, 350, 352, 354, 356, and 358 are collectively referred to in FIG. 3A as data communication 396. The UL data transmission (i.e., events 348, 350, 352) and DL data transmission (i.e., events 354, 356 and 358) can occur in parallel or one after the other.

Before turning to FIG. 3B, the remaining discussion for FIG. 3A provides additional details regarding the UL RRC messages that the UE 102 transmits 304, 330, and 344, and security functions. The UE RRC controller 156 generates the first UL RRC message, the second UL RRC message, and the third UL RRC message that the UE 102 transmits 304, 330, 344, respectively. To transmit 304 the first UL RRC message, the UE 102 in some implementations includes a (first) RRC MAC-I field (e.g., resumeMAC-I) in the first UL RRC message. For example, the UE 102 can obtain the RRC MAC-I from the 16 least significant bits of a MAC-I that the UE 102 calculates over an VarResumeMAC-Input variable with a first RRC integrity key (KRRCint) in a UE Inactive AS Context of the UE 102, a previously used integrity protection algorithm, and all input bits for COUNT, BEARER and DIRECTION set to binary ones. The VarResumeMAC-Input variable includes three fields: a source physical cell identity (sourcePhysCellId), a target cell identity (targetCellIdentity), and a source cell C-RNTI (source-c-RNTI).

To transmit 330 the second UL RRC message, the UE 102 in some implementations obtain a second RRC MAC-I in a manner described for obtaining the first RRC MAC-I. The UE 102 can include the second RRC MAC-I in the second UL RRC message. In other implementations, the UE 102 (e.g., the PDCP controller 154) can obtain a MAC-I from the second UL RRC message with a second RRC integrity key (KRRCint) to protect integrity of the second UL RRC message. The UE 102 (e.g., the PDCP controller 154) encrypts the second UL RRC message and the MAC-I with an RRC encryption key (KRRCenc) to generate an encrypted UL RRC message and an encrypted MAC-I respectively. The UE 102 then generates a UL PDCP PDU including the encrypted UL RRC message and the encrypted MAC-I. The UE 102 can generate a UL RLC PDU including the UL PDCP PDU and includes the RLC PDU in the second UL MAC PDU 330. In some implementations, the UE 102 derives the second RRC integrity key from a base key (e.g., KgNB). The UE 102 can derive the base key from the UE Inactive AS Context.

To transmit 344 the third UL RRC message, the UE 102 (e.g., the PDCP controller 154) can obtain a MAC-I from the third UL RRC message with the second KRRCint to protect integrity of the third UL RRC message. The UE 102 (e.g., the PDCP controller 154) encrypts the third UL RRC message and the MAC-I with the KRRCene to generate an encrypted UL RRC message and an encrypted MAC-I respectively. The UE 102 then generates a UL PDCP PDU including the encrypted UL RRC message and the encrypted MAC-I. The UE 102 can generate a UL RLC PDU including the UL PDCP PDU and includes the RLC PDU in the third UL MAC PDU 344.

To transmit each of the EDT UL data packet(s) at events 304, 316, the UE 102 in some implementations applies at least one security function to the EDT UL data packet with at least one security key to generate a security-protected packet. The at least one security function includes integrity protection and/or encryption. The at least one security key includes a UP encryption key (KUPenc) and/or a UP integrity key (KUPint) for the encryption and/or integrity protection respectively. The UE 102 can generate the KUPene and/or KuPint from the base key. After applying the at least one security function, the UE PDCP controller 154 includes the security-protected packet in a UL PDCP PDU. In some implementations, the MAC controller 152 includes the UL PDCP PDU in the UL MAC PDU 304 or 316. In further implementations, an RLC controller of the UE 102 (not shown in FIG. 1A) includes the UL PDCP PDU in a UL RLC PDU and the MAC controller 152 includes the UL RLC PDU in the UL MAC PDU 304 or 316.

To transmit each of the EDT DL data packet(s) at event 324, the CU 172 in some implementations applies at least one security function (e.g., a security function similar to the at least one security function applied by the UE 102 at events 304, 316) to the EDT DL data packet with at least one security key (same as the at least one security key used by the UE 102 at events 304, 316) to generate a security-protected packet. The at least one security function includes integrity protection and/or encryption (same as the integrity protection and/or encryption applied by the UE 102 at events 304, 316). The at least one security key includes a UP encryption key (KUPenc) (same as the KUPene used by the UE 102) and/or a UP integrity key (KUPint) (same as the KuPint used by the UE 102) for the encryption and/or integrity protection respectively. After applying the at least one security function, the BS PDCP controller 134 includes the security-protected packet in a DL PDCP PDU. In some implementations, the MAC controller 152 includes the DL PDCP PDU in the DL MAC PDU 326. In further implementations, an RLC controller of the DU 174 (not shown in FIG. 1A) includes the DL PDCP PDU in a DL RLC PDU, and the MAC controller 132 includes the DL RLC PDU in the DL MAC PDU 326.

To transmit the DL RRC message at event 338, the CU 172 in some implementations applies at least one security function (e.g., a security function similar to the at least one security function applied by the UE 102) to the DL RRC message with at least one security key (same as the at least one security key used by the UE 102) to generate a security-protected packet. The at least one security function includes encryption and/or integrity protection. The at least one security key includes an RRC encryption key (KRRCenc) (same as the KRRCene used by the UE 102) and/or an RRC integrity key (KRRCint) (same as the KRRCint used by the UE 102) for the encryption and/or integrity protection respectively. After applying the at least one security function, the PDCP controller 134 includes the security-protected packet in a DL PDCP PDU. In some implementations, the MAC controller 132 includes the DL PDCP PDU in the DL MAC PDU 340. In further implementations, an RLC controller of the DU 174 (not shown in FIG. 1A) includes the DL PDCP in a DL RLC PDU, and the MAC controller 132 includes the DL RLC PDU in the DL MAC PDU 340.

To transmit each of the UL data packet(s) at event 348, the UE 102 in some implementations applies at least one security function to the UL data packet with at least one security key to generate a security-protected packet. The at least one security function includes the encryption and/or integrity protection that the UE 102 applied at events 304, 316. In some implementations, the at least one security key includes the KUPene and/or the KuPint that the UE used at events 304, 316. In other implementations, the at least one security key includes a new KUPene and/or a new KuPint. The UE 102 can derive the new KuPene and/or the new KuPint in response to receiving 340 the DL RRC message. In such implementations, the CU 172 also derives a new KUPene (same as the new KUPene used by the UE 102) and/or a new KUPint (same as the new KuPint used by the UE 102) in response to transmitting 338 the DL RRC message. After applying the at least one security function, the PDCP controller 154 includes the security-protected packet in a UL PDCP PDU. In some implementations, the MAC controller 152 includes the UL PDCP PDU in the UL MAC PDU 348. In further implementations, an RLC controller of the UE 102 (not shown in FIG. 1A) includes the UL PDCP PDU in a UL RLC PDU and the MAC controller 132 includes the UL RLC PDU in the corresponding UL MAC PDU 348.

To transmit each of the DL data packet(s) at event 356, the CU 172 in some implementations applies at least one security function (e.g., a security function similar to the at least one security function applied by the UE 102 at event 348) to the DL data packet with at least one security key (same as the at least one security key used by the UE 102 at event 348) to generate a security-protected packet. The at least one security function includes the integrity protection and/or encryption (same as the integrity protection and/or encryption applied by the UE 102 at event 348). The at least one security key includes a UP encryption key (KUPenc) (same as the KUPenc used by the UE 102) and/or a UP integrity key (KUPint) (same as the KuPint used by the UE 102) for the encryption and/or integrity protection respectively. After applying the at least one security function, the PDCP controller 134 includes the security-protected packet in a DL PDCP PDU. In some implementations, the MAC controller 132 includes the DL PDCP PDU in the DL MAC PDU 358. In further implementations, an RLC controller of the DU 174 (not shown in FIG. 1A) includes the DL PDCP PDU in a DL RLC PDU, and the MAC controller 132 includes the DL RLC PDU in the DL MAC PDU 358.

Turning to FIG. 3B, the scenario 300B is similar to the scenario 300A. However, instead of the UE 102 detecting, while performing EDT, non-EDT UL data for transmission to the base station 104, the base station 104 detects, while performing EDT, non-EDT DL data for transmission to the UE 102. Initially, the CU 172 performs 390 initial early data communication with the UE 102 operating in the inactive state, via the DU 174. The CU 172 may also perform 392 early data communication with the UE 102 via the DU 174 to communicate subsequent UL/DL data with the UE 102 operating in the inactive state. After the initial early data communication 390 and before or during the early data communication 392 (i.e., before the EDT session ends), the CU 172 receives 362 non-EDT DL data from the CN 110 or an edge server.

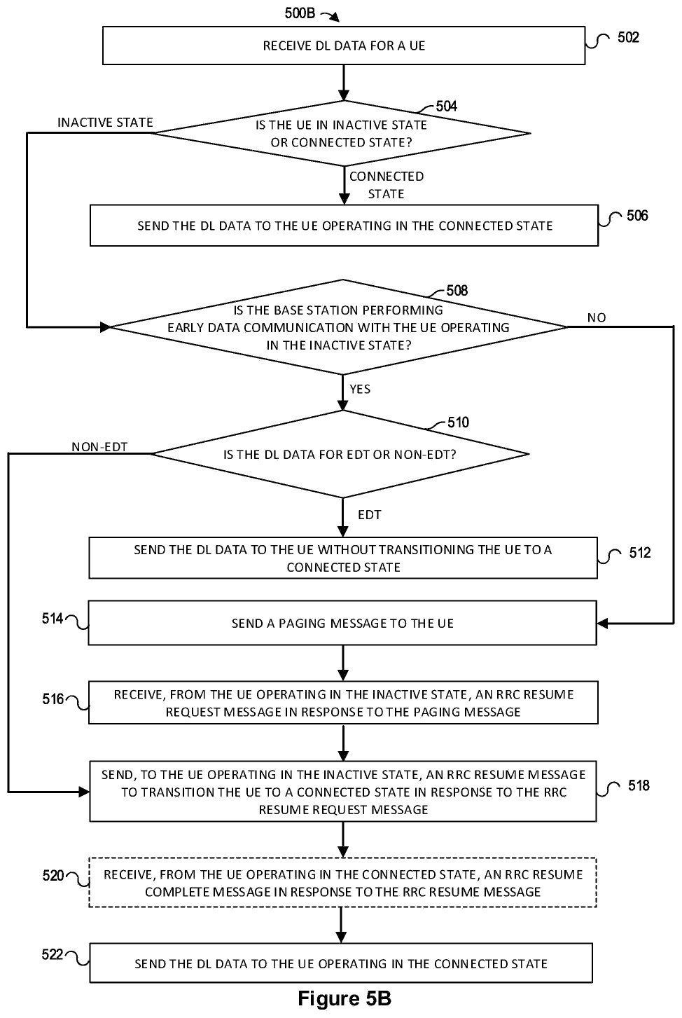

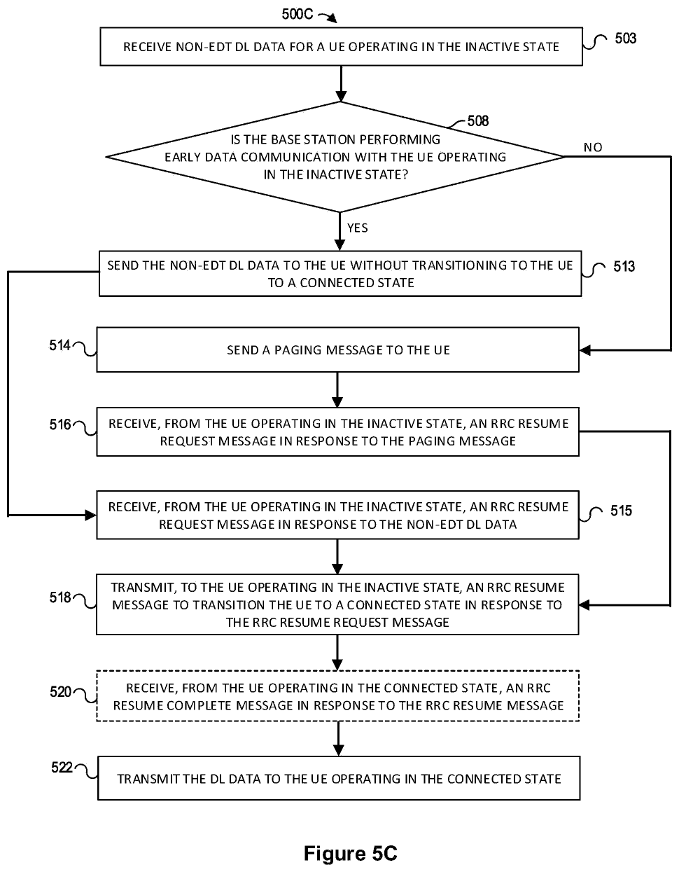

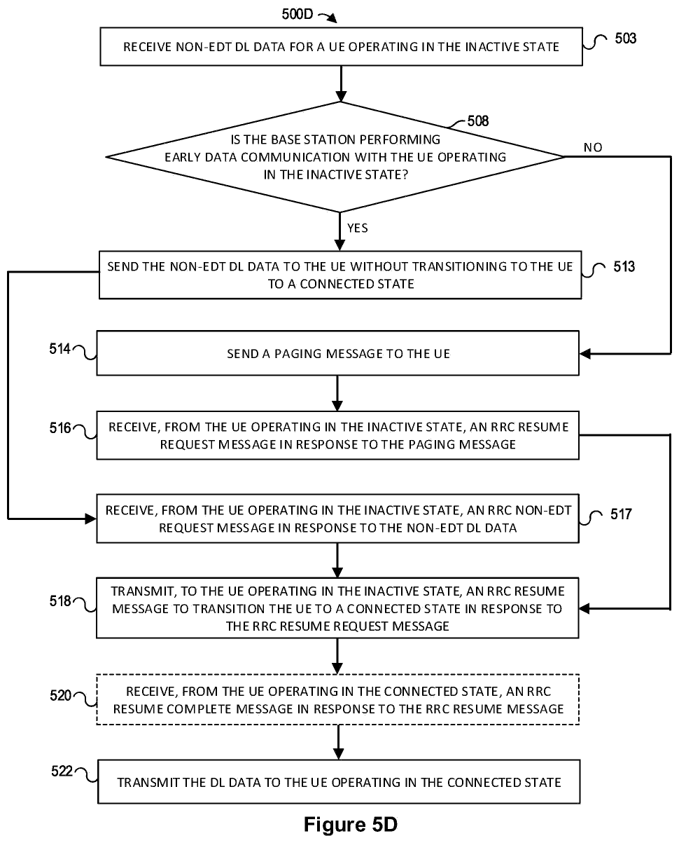

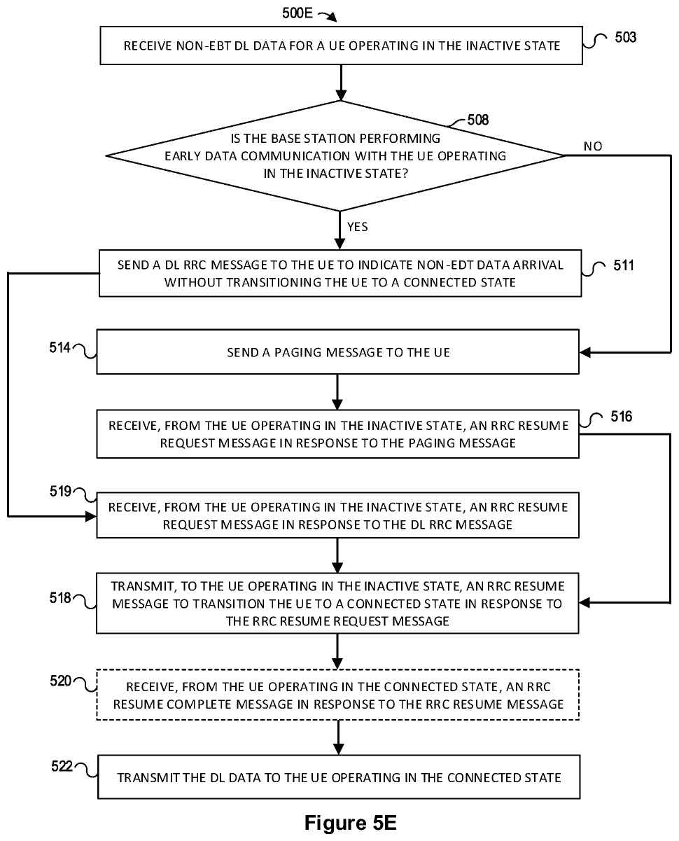

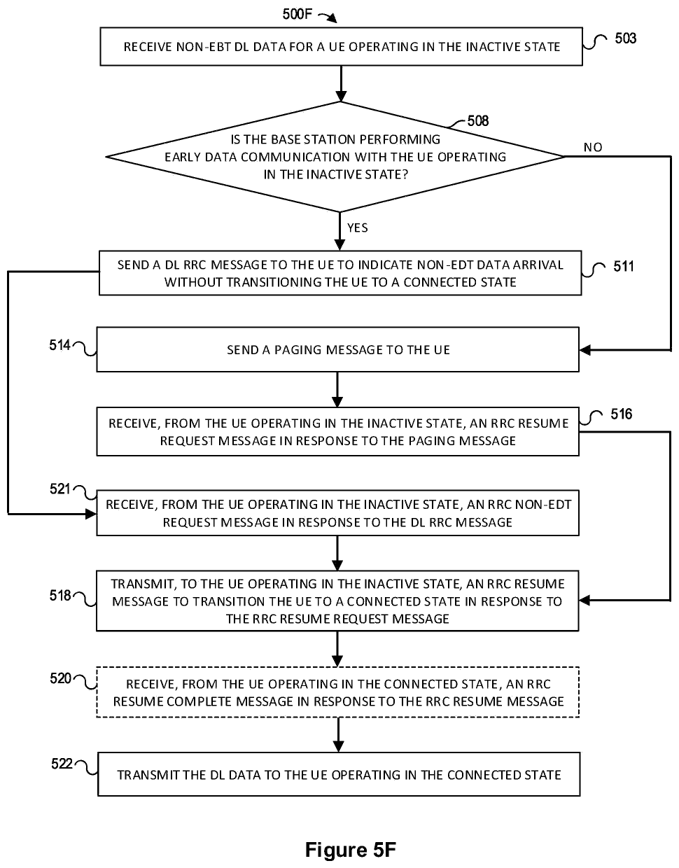

In response to receiving 362 the non-EDT DL data, the CU 172 determines 363 to send the non-EDT DL to the UE 102 without transitioning the UE 102 to the connected state. The CU 172 may make the determination 363 in response to observing that the CU 172 is performing EDT with the UE 102. Example methods that the CU 172 (or a base station 104) may implement to determine whether to transition the UE 102 to the connected state and how to manage non-EDT DL data detected while performing EDT are discussed in further detail with reference to FIGS. 4A-4F, 5A-5F. In particular, during the scenario 300B, the CU 172 may implement the method discussed with reference to FIG. 4C.

The CU 172 transmits 364 the non-EDT DL data to the DU 174, which includes the non-EDT DL data in a DL MAC PDU and transmits 366 the DL MAC PDU to the UE 102 while the UE 102 operates in the inactive state. To transmit 366 the DL MAC PDU to the UE 102, the DU 174 can utilize a non-EDT RB.

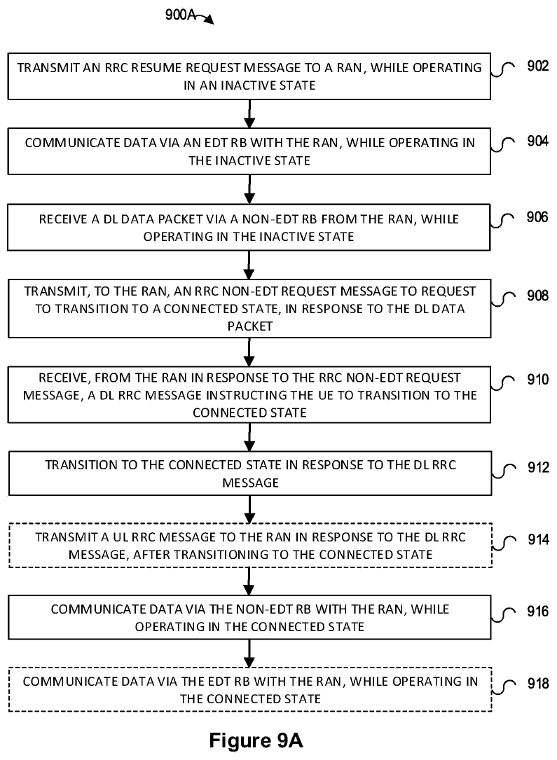

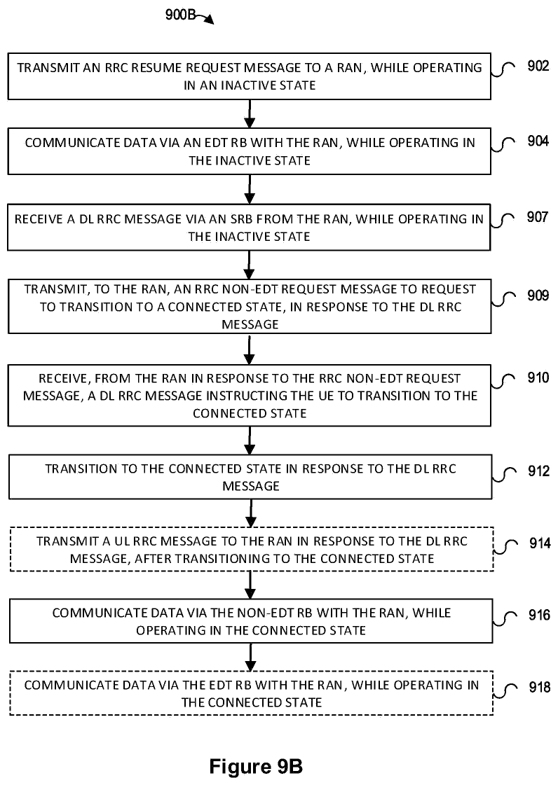

In response to receiving the non-EDT DL data, and/or in response to receiving the non-EDT DL data on a non-EDT RB, the UE 102 determines to transition to the connected state. Accordingly, the UE 102 initiates an RRC state transition procedure 394. UE-behaviors in response to receiving non-EDT DL data or DL RRC message from the base station 104 while operating in the inactive state are discussed in further detail below with reference to FIGS. 9A-9B.

After the UE 102 transitions to the connected state during the RRC state transition procedure 394, the CU 172 can communicate UL and/or DL data during the data communication 396.

Referring next to FIG. 3C, a scenario 300C is similar to the scenario 300B. However, after receiving 362 the non-EDT DL data, the CU 172 determines 361 to send an indication of non-EDT DL data (rather than the non-EDT DL data itself) to the UE 102 without transitioning the UE 102 to the connected state. The CU 172 may make the determination 361 in response to observing that the CU 172 is performing EDT with the UE 102. To notify the UE 102 of the non-EDT DL data, the CU 172 transmits 365 a DL RRC message indicating DL data arrival. The CU 172 can send 365 a CU-to-DU message (e.g., DL RRC Message Transfer message) including the DL RRC message to the DU 174. The DU 174 includes the DL RRC message in a DL MAC PDU and transmits 367 the DL MAC PDU to the UE 102. The DU 174 may use a logical channel associated to an SRB (e.g., SRB1), which may be an EDT SRB or a non-EDT SRB, to transmit the DL MAC PDU. For example, the DU 174 can include the DL RRC message (i.e., security-protected DL RRC message) in a DL PDCP PDU as described above, include the DL PDCP PDU in a DL RLC PDU, include the DL RLC PDU in the DL MAC PDU, and include a logical channel identity of the logical channel in the MAC PDU to indicate the DL RLC PDU. The CU 172 can include an SRB identity of the SRB in the CU-to-DU message so that the DU 174 can derive the logical channel identity based on the SRB identity. The CU 172 therefore notifies the UE 102 of the available non-EDT DL data while the UE 102 operates in the inactive state. In response to the DL RRC message with DL data arrival indicator that the UE 102 receives 367, the UE 102 performs an RRC state transition procedure 394 to transition to the connected state, and communicates UL and/or DL data during the data communication procedure 396. After the UE 102 transitions to the connected state, the CU 172 transmits the non-EDT data that the CU 172 earlier received 362 to the UE 102 during the data communication procedure 396. As will be discussed below, during the scenario 300C, the CU 172 may implement the method discussed with reference to FIG. 4E.

FIGS. 4A-5F are flow diagrams depicting example methods that a network node of a RAN (e.g., a network node of the RAN 105, such as the DU 174, the CU 172, or the base station 104) or a UE (e.g., the UE 102) can implement. As indicated at various points throughout the disclosure, the example methods depicted in FIGS. 4A-5F may be implemented during the scenarios 300A-C described above. Generally speaking, similar blocks in FIGS. 4A-5F are labeled with the same reference numbers (e.g., block 402 in FIG. 4A is equivalent to block 402 in FIG. 4B).

FIGS. 4A-4F illustrate example methods 400A-400F, respectively, in which a CU (e.g., the CU 172) determines how to manage DL data for a UE (e.g., the UE 102) based on whether the UE is operating in an inactive state and whether the DL data is (or is not) eligible for EDT.

Turning first to FIG. 4A, during the method 400A, at block 402, a CU receives DL data for a UE (e.g., events 322, 354, 362). At block 404, the CU determines whether the UE is operating in an inactive state or a connected state. If the UE is operating in a connected state, then the CU at block 406 sends the DL data, via a DU (e.g., the DU 174), to the UE operating in the connected state (e.g., event 356). If the UE is operating in an inactive state, then the CU at block 408 determines whether the CU is performing EDT with the UE operating in the inactive state. If not, then the flow proceeds to block 414. Otherwise, the CU determines at block 410 whether the DL data is eligible for EDT or not. If the DL data is eligible for EDT, then at block 412 the CU sends the DL data to the UE via the DU without transitioning the UE to a connected state (e.g., event 324). If the DL data is not eligible for EDT (e.g., as at event 362), then the flow proceeds to block 414.

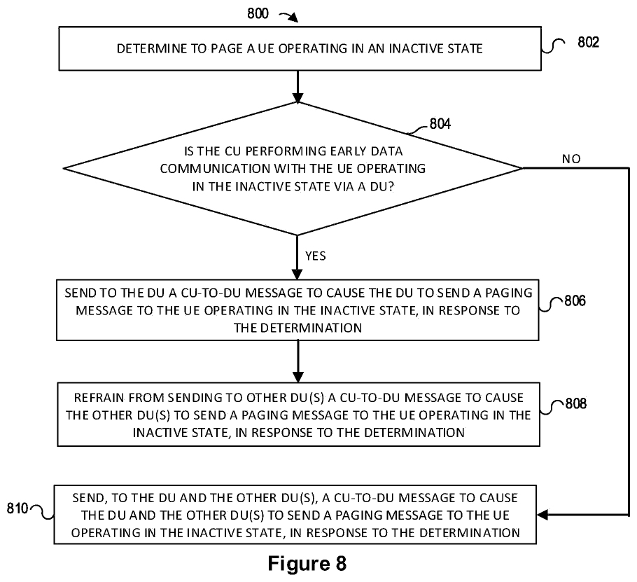

At block 414, the CU sends a CU-to-DU message to one or more DUs to cause the DU(s) to send a paging message to the UE operating in the inactive state. For example, the CU may send the CU-to-DU message to DU(s) in a paging area of the UE, such as those DU(s) identified in a tracking area identity (TAI) list and/or RNA of the UE. To determine whether to page a single DU or multiple DUs, the CU may utilize a method discussed below with reference to FIG. 8. Paging the UE is an alternate solution to the methods illustrated in FIGS. 3B-3C, in which the CU does not page the UE. The methods illustrated in FIGS. 3B-3C are discussed below with reference to FIGS. 4C and 4E, respectively.

At block 416, the CU receives, from the UE operating in the inactive state via one of the DU(s), an RRC resume request message in response to the paging message (e.g., event 330). In response to the RRC resume request message, at block 418, the CU sends, to the UE operating in the inactive state via the DU, an RRC resume message to transition the UE to a connected state (e.g., events 338, 340). At block 420, in response to the RRC resume message, the CU receives, from the UE operating in the connected state via the DU, an RRC resume complete message (e.g., events 344, 346). At block 422, the CU sends the DL data via the DU to the UE operating in the connected state (e.g., events 356, 358).

Turning to FIG. 4B, the method 400B is generally similar to the method 400A, but with the CU instructing the UE to transition to the connected state to receive non-early DL data without using a paging procedure. In the method 400A, if the CU determines at block 410 that the DL data is not eligible for EDT, the CU at block 414 sends a CU-to-DU message to cause a DU to page the UE. In contrast, in the method 400B, if the CU determines at block 410 that the DL data is not eligible for EDT, the CU proceeds directly to block 419 without causing the DU to page the UE. At block 419, the CU sends, to the UE operating in the inactive state via the DU, an RRC resume message to transition the UE to a connected state.

Turning to FIG. 4C, in a method 400C, the CU transmits non-EDT data to the UE without instructing the UE to transition to the connected state, if the UE currently is performing early-data communication, as illustrated in FIG. 3B. At block 403, the CU receives non-EDT DL data for a UE operating in the inactive state (e.g., event 362). At block 408, the CU determines whether the CU is performing EDT with the UE operating in the inactive state via a DU (e.g., events 363, 361). If so, then at block 413 the CU sends the non-EDT DL data to the UE via the DU without transitioning the UE to a connected state (e.g., events 364, 366). The method can then proceed from block 413 to block 415. At block 415, the CU receives, from the UE operating in the inactive state via one of the DU(s), an RRC resume request message in response to the non-EDT DL data (e.g., event 332). The flow can then proceed to block 418.

If the CU determines at block 408 that the CU is not performing EDT with the UE, then the flow proceeds from block 408 to blocks 414, 416, and 418 as described previously with respect to FIG. 4A. From block 418, the flow proceeds to blocks 420 and 422 as described previously with respect to FIG. 4A.

Turning to FIG. 4D, the method 400D is similar to the method 400C, except that the UE transmits a dedicated RRC message to request communication of non-EDT DL data. In particular, the method 400D is the same as the method 400C, except that block 415 in FIG. 4C is replaced by block 417 in FIG. 4D. At block 417, the CU receives, from the UE operating in the inactive state via one of the DU(s), an RRC non-EDT request message in response to the non-EDT DL data. The RRC non-EDT request message indicates to the CU that the UE is requesting a transition to the connected state to communicate non-EDT DL or UL data. In some implementations, the RRC non-EDT request message may be a new RRC resume request, which may be defined in future 3GPP standards documentation. In other implementations, the RRC non-EDT request can be an existing RRC message (e.g., UEAssistanceInformation message) or a new UL RRC message, and the CU receives a DCCH message (e.g., UL-DCCH-Message) including the RRC non-EDT message from the UE via the DU.

In some implementations, the CU can transmit an RRC reconfiguration message or a new DL RRC message to transition the UE to the connected state instead of using the RRC resume message.

Turning to FIG. 4E, the method 400E includes transmitting to the UE a DL RRC message to indicate that non-EDT DL data is available, as illustrated in FIG. 3C. If the DU determines at block 408 that the CU is performing early data communication with the UE operating in the inactive state, then the CU at block 411 sends a DL RRC message to the UE via the DU to indicate non-EDT data arrival, without transitioning the UE to a connected state (e.g., events 365, 367). From block 411, the flow proceeds to block 419, where the CU receives, from the UE operating in the inactive state, an RRC resume request message in response to the DL RRC message (e.g., event 332). From block 418, the flow proceeds to blocks 420 and 422, where the CU can transmit the DL data (i.e., the pending non-EDT DL data) to the UE operating in the connected state via the DU (e.g., event 396).

Turning to FIG. 4F, the method 400F is similar to the method 400E, but with the UE transmitting a dedicated RRC message to request communication of non-EDT data, similar to the method 400D. After sending a DL RRC message to the UE via the DU to indicate non-EDT data arrival at block 411, the flow proceeds to block 421. At block 421, the CU receives, from the UE operating in the inactive state via one of the DU(s), an RRC non-EDT request message in response to the DL RRC message. The RRC non-EDT request message indicates to the CU that the UE is requesting to transition to the connected state to receive non-EDT DL data. The RRC non-EDT request message may be a new RRC resume request, which may be defined in future 3GPP standards documentation. Block 421 in FIG. 4F is similar to block 417 in FIG. 4D, except that in FIG. 4F, the CU has not yet transmitted the non-EDT DL data that the CU received at block 403. Accordingly, at block 422, after the UE transitions to the connected state, the CU sends the non-EDT DL data to the UE via the DU.

FIGS. 5A-F illustrate methods 500A-F, which are similar to the methods 400A-F, respectively, but implemented in a non-distributed base station. Blocks in FIGS. 5A-5F labeled with similar reference numbers to those of FIGS. 4A-4F are generally similar (e.g., block 402 is similar to block 502). A non-distributed base station performs the functions that the CU performs in FIGS. 4A-4F, except that the non-distributed base station communicates with the UE directly rather than via a DU. CU-to-DU messages are therefore not exchanged in FIGS. 4A-4F.

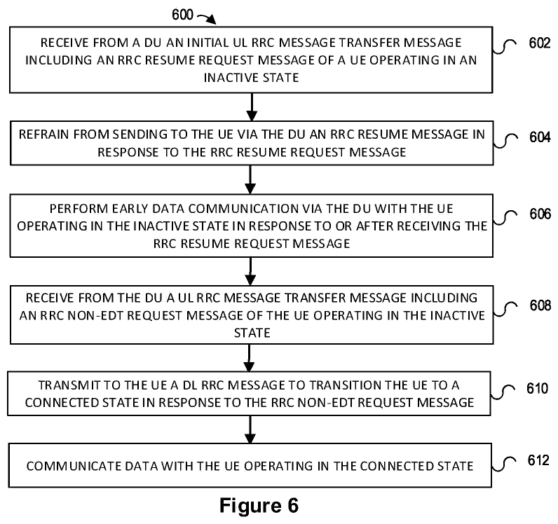

FIG. 6 illustrates a method 600, which can be implemented by a CU (e.g., the CU 172) for initiating EDT with a UE (e.g., the UE 102) after receiving a request to resume a radio connection between the UE and a RAN (e.g., the RAN 105). At block 602, the CU receives, from a DU, an Initial UL RRC Message Transfer message including an RRC resume request message from a UE operating in an inactive state (e.g., event 306). In some implementations, the CU at block 602 can receive a CCCH message (e.g., a UL-CCCH-Message) including the RRC resume request message from the DU. At block 604, the CU refrains from sending to the UE, via the DU, an RRC resume message in response to the RRC resume request message. At block 606, the CU performs EDT, via the DU, with the UE operating in the inactive state, in response to or after receiving the RRC resume request message (e.g., event 390, 392).

At block 608, the CU receives, from the DU, a UL RRC Message Transfer message including an RRC non-EDT request message from the UE operating in the inactive state (e.g., event 332). The RRC non-EDT request message may be a dedicated RRC message to request communication of non-EDT data (e.g., as discussed above with reference to FIGS. 4D and 4F). In some implementations, the CU receives a DCCH message (e.g., a UL-DCCH-Message) including the RRC non-EDT request message from the UE. In some implementations, the RRC non-EDT request message is an existing RRC message (e.g., UEAssistanceInformation message). In other implementations, the RRC non-EDT request message is a new RRC message which may be defined in future 3GPP standards documentation.

At block 610, the CU transmits to the UE, via the DU, a DL RRC message to transition the UE to a connected state in response to the RRC non-EDT request message (e.g., event 338, 340). The DL RRC message may include one or more radio configurations (e.g., a CellGroupConfig 1E and/or a RadioBearerConfig 1E). The DL RRC message may be an RRC reconfiguration message, an RRC resume message, or may be a new RRC message. At block 612, the CU communicates data with the UE operating in the connected state (e.g., event 396).

FIGS. 7A-7B illustrate methods 700A-700B, respectively, that a CU (e.g., the CU 172), can perform for selecting a UE Context Modification procedure or a UE Context Setup procedure when transitioning a UE to a connected state. Referring first to FIG. 7A, at block 702, the CU receives a UL RRC message via a DU from a UE operating in an inactive state (e.g., event 332). At block 704, the CU determines to transition the UE to a connected state in response to the UL RRC message. At block 706, the CU determines whether the UL RRC message is a CCCH message or a DCCH message. If the UL RRC message is a CCCH message (e.g., the CU receives the UL RRC message via a CCCH or SRB0 or receives a UL-CCCH-Message including the UL RRC message), then the CU at block 708 performs a UE Context Setup procedure with the DU to obtain a radio configuration for the UE. For example, the CCCH message may be an RRC resume request message. If the UL RRC message is a DCCH message (e.g., the CU receives the UL RRC message via a DCCH or

SRB1 or receives a UL-DCCH-Message including the UL RRC message), then the CU at block 710 performs a UE Context Modification procedure with the DU to obtain a radio configuration for the UE (e.g., events 334, 336). For example, the DCCH message may be a UEAssistanceInformation message or a new RRC message. The CU transmits a DL RRC message including the radio configuration (obtained either at block 708 or 710) to the UE via the DU at block 712 (e.g., events 338, 340). The radio configuration may include a CellGroupConfig 1E and/or a RadioBearerConfig 1E. The DL RRC message may be an RRC resume message, an RRC reconfiguration message, or a new RRC message.

Turning to FIG. 7B, the method 700B is similar to the method 700A. However, the block 706 in FIG. 7A is replaced with block 707 in FIG. 7B. At block 707, the CU determines whether the UL RRC message that the CU received at block 704 is an RRC resume request message. If so, then the flow proceeds to block 708. Otherwise, the flow proceeds to block 710.

FIG. 8 is a flow diagram of a method 800, which can be implemented by a CU (e.g., the CU 172), for determining whether a single DU or multiple DUs should page a UE depending on whether the UE currently is performing early-data communication. At block 802, the CU determines to page a UE operating in an inactive state (e.g., block 414). At block 804, the CU determines whether the CU is performing EDT with the UE operating in the inactive state via a DU. If so, then the CU at block 806 sends, to that single DU, a CU-to-DU message to cause the DU to send a paging message to the UE operating in the inactive state. The CU also refrains, at block 808, from sending such a CU-to-DU message to other DUs. If the CU is not performing EDT with the UE via a DU, then the CU sends, at block 810, to the DU and the other DU(s) (e.g., other DUs in a paging area of the UE), a CU-to-DU message to cause multiple DU(s) to send a paging message to the UE operating in the inactive state.

FIGS. 9A-9B illustrate methods 900A-900B, respectively, which a UE (e.g., the UE 102) can perform a state transition procedure with a RAN during early data transmission. Referring first to FIG. 9A, at block 902, the UE transmits an RRC resume request message to a RAN while operating in an inactive state (e.g., event 304, 306). At block 904, the UE communicates data with the RAN via an EDT RB while operating in the inactive state (e.g., events 390, 392). At block 906, the UE receives a DL data packet via a non-EDT RB from the RAN, while operating in the inactive state (e.g., event 366). At block 908, in response to the DL data packet, the UE transmits, to the RAN, an RRC non-EDT request message to request to transition to a connected state (e.g., event 330). The UE can then receive, at block 910, from the RAN, a DL RRC message instructing the UE to transition to the connected state (e.g., event 340). In response, the UE transitions to the connected state at block 912 (e.g., event 342).

In response to the DL RRC message, the UE may transmit, at block 914, a UL RRC message to the RAN after transitioning to the connected state (e.g., event 344). At block 916, the UE communicates data via the non-EDT RB with the RAN, while operating in the connected state (e.g., event 396). The UE, in some implementations, communicates data via the EDT RB with the RAN, while operating in the connected state, at block 918 (e.g., event 396). In some implementations, the UE can determine that the EDT RB becomes a non-EDT RB in response to or after transitioning to the connected state. In other implementations, the UE can determine the EDT RB is no longer subject to EDT in response to or after transitioning to the connected state. In other words, the UE determines to release EDT indication(s) (i.e., received in a RRC release message from the RAN) associated with the EDT RB(s) in response to or after transitioning to the connected state. The UE can release the EDT indication(s) in response to or after transitioning to the connected state.

Referring next to FIG. 9B, the method 900B is generally similar to the method 900A. However, at block 907, the UE receives a DL RRC message via an SRB from the RAN while operating in the inactive state (e.g., event 367), rather than receiving a DL data packet via a non-EDT RB as at block 906. The DL RRC message indicates DL data arrival for the UE. In response to the DL RRC message, the UE transmits, to the RAN, an RRC non-EDT request message to request to transition to a connected state, at block 909. After the UE transitions to the connected state, the UE can receive the DL data via the non-EDT RB at block 916 (i.e., the DL data indicated by the DL RRC message).

FIG. 10 is a flow diagram of a method 1000, which can be implemented by a UE (e.g., the UE 102) for selecting a UL message for transitioning to the connected state, based at least in part on whether the UE currently is performing EDT. At block 1002, the UE operates in an inactive state with a RAN (e.g., event 302). At block 1004, the UE determines to transition to a connected state from the inactive state. At block 1006, the UE determines whether the UE is performing EDT with the RAN. If so, then the UE transmits a first UL message to the RAN in response to the determination at block 1004 (e.g., event 330). Otherwise, the UE transmits a second UL message to the RAN in response to the determination at block 1004. The first UL message may be an RRC non-EDT request message, which may indicate that the UE is requesting to communicate non-EDT data with the RAN. The second UL message may be an RRC resume request message, which may request that the RAN transition the UE to the connected state. The first UL message may be a DCCH message (e.g., a UEAssistanceInformation message or a new RRC message), and the second UL message may be a CCCH message (e.g., an RRC resume request message), as described for FIG. 7. In some implementations, the UE transmits the first UL message via a first SRB (e.g., SRB0), and transmits the second UL message via a second SRB (e.g., SRB1).

After transmitting either the first or second UL message, at block 1012, the UE receives, from the RAN in response to the UL message, a DL message instructing the UE to transition to the connected state (e.g., event 340). The DL message may be an RRC resume message. Depending on the implementation, the DL message may be a CCCH message (e.g., the UE receives the DL message via a CCCH or receives a DL-CCCH-Message including the DL message) or a DCCH message (e.g., the UE receives the DL message via a DCCH or receives a DL-DCCH-Message including the DL message). The UE may receive the DL message via the first SRB or via the second SRB. In some implementations, the DL message includes a radio configuration, which may include configuration parameters of a PHY layer, a MAC layer, and/or an RLC layer. Further, in some implementations, the DL message includes a CellGroupConfig 1E.

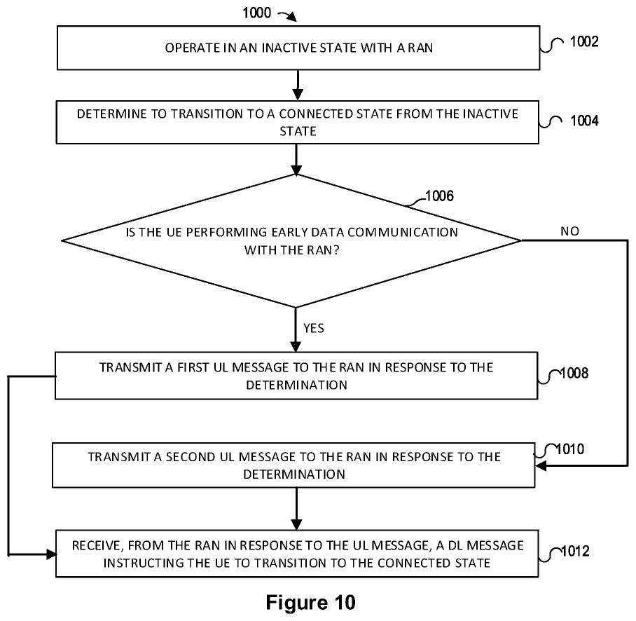

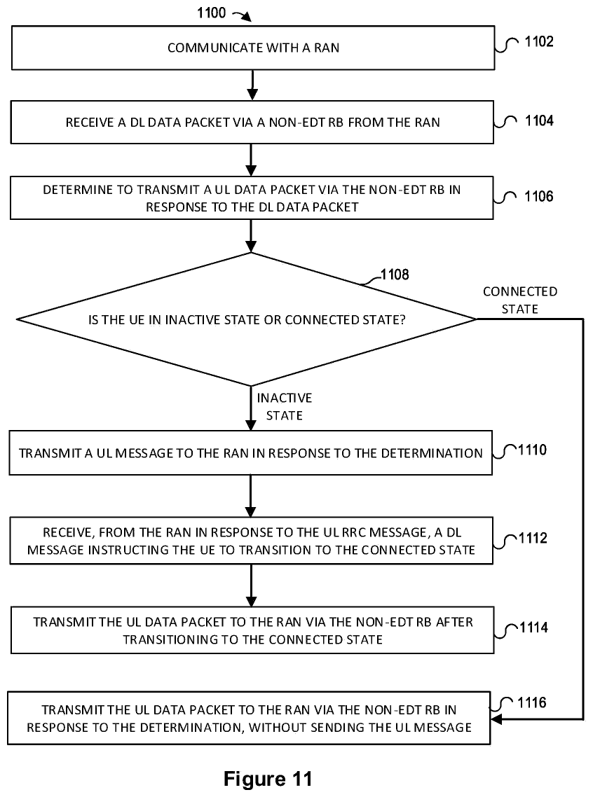

FIG. 11 is a flow diagram of a method 1100 in a UE (e.g., the UE 102) for selecting a radio bearer for transmitting UL data based on whether the UE received a DL data packet in a connected or inactive state. At block 1102, the UE communicates with a RAN. At block 1104, the UE receives a DL data packet via a non-EDT RB from the RAN (e.g., event 366). At block 1106, the UE determines to transmit a UL data packet via the non-EDT RB in response to the DL data packet. At block 1108, the UE determines whether the UE is operating in the inactive state or the connected state. If operating in the inactive state, then the UE transmits at block 1110 UL message to the RAN (e.g., event 330). At block 1112, the UE receives, from the RAN in response to the UL message, a DL message that instructs the UE to transition to a connected state (e.g., event 340). The UE can then transmit the UL data packet to the RAN via the non-EDT RB after transitioning to the connected state, at block 1114 (e.g., event 348). If operating in the connected state, then the UE transmits at block 1116 the UL data packet to the RAN via the non-EDT RB, without sending the UL message (e.g., event 348).

In some implementations, the UE at block 1114 may not have an available UL grant to transmit the UL data packet. In such cases, the UE can send a scheduling request (i.e., a physical layer signal) to the RAN to obtain an UL grant from the RAN. In response to the scheduling request, the RAN can generate a UL grant, include the UL grant in a DCI, generate a CRC of the DCI, and transmit the DCI and CRC on a PDCCH to the UE. Alternatively, the UE at block 1114 can perform a random access procedure with the RAN to obtain a UL grant from the RAN. In the random access procedure, the UE transmits a random access preamble to the RAN. In response to the random access preamble, the RAN can send a random access response including an UL grant to the UE. After receiving the UL grant from the RAN, the UE transmits (a portion of) the UL data packet to the RAN in accordance with the UL grant. In cases that the UE transmits a portion of the UL data packet, the UE can transmit other portion(s) of the UL data packet to the RAN in accordance with other DCI(s) that the UE receives on PDCCH(s).

FIG. 12 is a flow diagram of a method 1200 in a UE (e.g., the UE 102) for selecting a radio bearer for transmitting UL data in an inactive state, depending on the radio bearer with which the UL data is associated. At block 1202, the UE receives, from a RAN, a DL RRC message configuring a DRB as an EDT DRB (e.g., the DL RRC message indicates that the DRB is an EDT DRB, or fails to indicate that the DRB is a non-EDT RB) (e.g., a DL RRC message received prior to operating 302 in the inactive state in FIG. 3A). The DL RRC message does not configure a first SRB as an EDT SRB (e.g., the DL RRC message indicates that the first SRB is a non-EDT SRB, or fails to indicate that the first SRB is an EDT SRB). The DL RRC message may instruct the UE to transition from a connected state to an inactive state. For example, the DL RRC message may be an RRC release message or an RRC reconfiguration message or command. At block 1204, the UE performs early data communication with the RAN while operating in the inactive state (e.g., event 390, 392). At block 1206, the UE determines, while operating in the inactive state, to transmit UL data to the RAN.

At block 1208, the UE determines whether the UL data is associated to a first SRB (e.g., SRB0 or SRB1), an EDT DRB, or a non-EDT DRB. If associated to a first SRB (e.g., SRB0 or SRB1), then the UE transmits the UL data to the RAN via the first SRB without transitioning to a connected state, at block 1210 (e.g., event 304). If associated to an EDT DRB, then the UE transmits the UL data to the RAN via the EDT DRB without transitioning to the connected state, at block 1212 (e.g., event 316). If associated to a non-EDT DRB, then the UE transmits, to the RAN, a first UL RRC message to request to transition to the connected state, at block 1214 (e.g., an RRC non-EDT request message or an RRC resume request message) (e.g., event 330).

Following block 1214, the UE receives, at block 1216, from the RAN in response to the second DL RRC message, a second DL RRC message instructing the UE to transition to the connected state (e.g., event 340). In response, the UE transitions to the connected state at block 1218 (e.g., event 342). In response to the second DL RRC message, the UE may transmit, at block 1220, a second UL RRC message to the RAN after transitioning to the connected state (e.g., event 344). At block 1222, the UE communicates data via the non-EDT DRB with the RAN, while operating in the connected state (e.g., event 396). The UE, in some implementations, communicates data via the EDT DRB with the RAN, while operating in the connected state, at block 1224 (e.g., event 396).

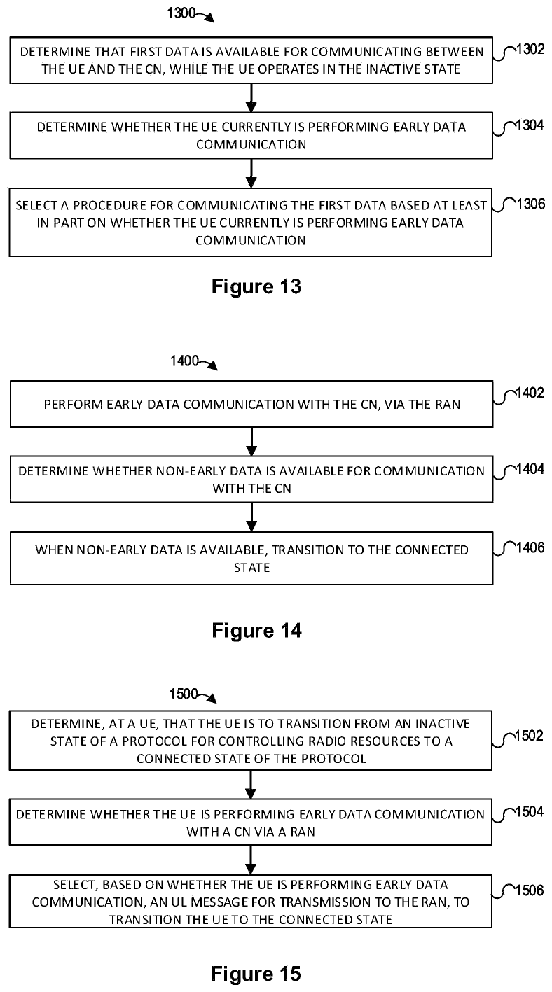

FIG. 13 is a flow diagram of a method 1300 for facilitating data communication between a UE (e.g., the UE 102) and a CN (e.g., the CN 110), which can be implemented in a base station (e.g., the base station 104). At block 1302, the base station determines that first data is available for communicating between the CN and the UE operating in an inactive state of a protocol for controlling radio resources (e.g., RRC_INACTIVE) (e.g., event 362). At block 1304, the base station determines whether the UE is performing early-data communication of second data. At block 1306, the base station selects a procedure for communicating the first data based at least in part on whether the UE is performing early-data communication. The base station, for example, may select a procedure for communicating the first data from the procedures described with reference to FIGS. 4A-4F and FIGS. 5A-5F.

In some implementations, the first data is DL data received from the CN (e.g., event 362). In such implementations, the selecting may be further based on whether the DL data qualifies for early data transmission to the UE (e.g., blocks 410, 510).

In some implementations, when the first data does not qualify for EDT, the selecting at block 1306 may include selecting a paging procedure, which may include transmitting a paging message to the UE (e.g., blocks 414, 514). After transmitting the paging message, the base station may receive a request to resume a radio connection between the UE and the RAN (e.g., blocks 416, 516). The base station can then transmit, to the UE in response to the request, a command to resume the radio connection (e.g., blocks 418, 518).

In some implementations, when the first data does not qualify for EDT, the selecting at block 1306 may include selecting a procedure for resuming a suspended radio connection between the UE and the RAN, which may include transmitting to the UE a command to resume the radio connection (e.g., blocks 419, 519). In such cases, the base station can omit a paging procedure.

In some implementations, when the first data does not qualify for EDT, the selecting at block 1306 may include selecting a procedure for transmitting non-EDT data over a suspended radio connection, including transmitting to the UE a data packet that includes at least a portion of the DL data, while the UE continues to operate in the inactive state (e.g., event 364, 366, blocks 413, 513). The base station may receive, from the UE and in response to the data packet, a request to resume a radio connection between the UE and the RAN, and may transmit, to the UE and in response to the request, a command to resume the radio connection (e.g., blocks 415, 418, 515, 518).

In some implementations, when the first data does not qualify for EDT, the selecting at block 1306 may include selecting a procedure for notifying the UE of non-early DL data, including transmitting to the UE a message associated with the protocol for controlling radio resources, the message indicating arrival of the first data, while the UE continues to operate in the inactive state (e.g., events 365, 367, blocks 411, 511). The base station may receive, from the UE and in response to the message, a request to resume a radio connection between the UE and the RAN, and may transmit, to the UE and in response to the request, a command to resume the radio connection (e.g., blocks 421, 418, 521, 518).

The above functionality described with reference to the method 1300 may be implemented in a CU of the base station, where the base station includes the CU and a DU.

In some implementations, determining that the first data is available includes receiving, at a CU of the base station from the UE via a DU of the base station, an UL message associated with the protocol for controlling radio resources (e.g., events 306, 332). The selecting at block 1306 may be further based on the UL message. The UL message may be dedicated to requesting communication of non-EDT data (e.g., block 608). In some implementations, the selecting includes selecting a UE context setup procedure in response to determining that the UL message received over a CCCH, and selecting a UE context modification procedure in response to determining that the UL message was received over a DCCH (e.g., blocks 706, 708, 710). In some implementations, the selecting includes selecting a UE context setup procedure in response to determining that the UL message is a request to resume a radio connection between the UE and the DU, and selecting a UE context modification procedure in response to determining that the UL message is a message other than the request to resume the radio connection (e.g., blocks 707, 708, 710).

Further, in some implementations, the method 1300 may be implemented in a CU of the base station including the CU and a plurality of DUs. Selecting the procedure may include, in response to determining that the UE is performing early-data communication, sending a request to page the UE only to a UE via which the UE is performing early-data communication (e.g., block 806), and, in response to determining that the UE is not performing early-data communication, sending a request to page the UE to each of the plurality of DUs (e.g., block 810).

FIG. 14 is a flow diagram of a method 1400 for communicating data with a CN (e.g., the CN 110), which can be implemented in a UE (e.g., the UE 102). At block 1402, the UE performs, in an inactive state of a protocol associated with controlling radio resources (e.g., RRC_INACTIVE), an early data communication with the CN (e.g., event 390, 392). At block 1404, the UE determines, while the UE continues to operate in the inactive state, whether non-early data (i.e., non-EDT data) is available for communicating between the UE and the RAN (e.g., event 328). In some implementations, determining that non-early data is available includes receiving, from the RAN and via a non-early DRB, a DL data packet (e.g., event 366, blocks 906, 1104). In such implementations, the UE may transmit an UL data packet via the non-early DRB (e.g., event 1106). In some implementations, determining that non-early DL data is available includes receiving, from the RAN and via an SRB, a message indicating that non-early DL data is available (e.g., event 367, block 907).

At event 1406, when non-early data is available, the UE transitions to a connected state of the protocol (e.g., RRC_CONNECTED) (e.g., event 330, 342, 394). In some implementations, in response to determining that the non-early data is available, the UE transmits, to the RAN, a request to transition to the connected state (e.g., event 330, blocks 908, 909). In some cases, transmitting the request may include transmitting a DCCH message, which may be a UE assistance information message (e.g., a UEAssistanceInformation message). In other cases, transmitting the request includes transmitting a CCCH message, which may be an RRC resume request. Further, in some implementations, in response to determining that the non-early data is available for communication in an UL direction from the UE to the RAN, the UE may transmit a buffer status report (BSR) to the RAN (e.g., at event 330).

Determining to transition to the connected state may further be in response to determining that the non-early data is associated with a non-early DRB (e.g., blocks 1208, 1214).

Prior to transitioning to the inactive state (e.g., prior to event 302), the UE may receive a message indicating a radio bearer allocated for early data communication (i.e., indicating an EDT RB). The message may be an RRC release indication, or may be a DL RRC reconfiguration command. Depending on the implementation, the UE may be configured with a plurality of RBs (i.e., one or more DRBs, one or more SRBs), and the method 1400 may further include determining which of the plurality of RBs is configured for EDT based on a radio bearer type.

Subsequently to transitioning to the connected state, the UE may communicate the non-early data using (i) a first RB configured for early data communication (i.e., an EDT RB), and (ii) a second RB configured for non-early data communication (i.e., a non-EDT RB) (e.g., during event 396, blocks 914-918).

FIG. 15 is a flow diagram of a method 1500 for transitioning between states of a protocol for controlling radio resources between a UE (e.g., the UE 102) and a RAN (e.g., the RAN 105) (e.g., an RRC protocol), which can be implemented in the UE. At block 1502, the UE determines that the UE is to transition from an inactive state of the protocol to a connected state of the protocol (e.g., block 1004). At block 1504, the UE determines whether the UE is performing early data communicating with a CN via the RAN (e.g., block 1006). At block 1506, the UE selects, based on whether the UE is performing early data communication, an UL message for transmission to the RAN, to transition to the connected state. In some cases, the selecting includes selecting a DCCH message. The DCCH message may be a UE assistance information message (e.g., a UEAssistanceInformation message), a new RRC message, or a UL-DCCH-Message message including the UE assistance information or the new RRC message. In other cases, the selecting includes selecting a CCCH message. The CCCH message may be an RRC resume request message or a UL-CCCH-Message message including the RRC resume request message.

The following list of examples reflects a variety of the embodiments explicitly contemplated.

Example 1 is a method implemented in a base station operating in a radio access network (RAN), for facilitating data communication between a UE and a core network (CN). The method includes: (1) determining, by processing hardware, that first data is available for communicating between the CN and the UE operating in an inactive state of a protocol for controlling radio resources; (2) determining, by the processing hardware, whether the UE is performing early-data communication of second data; and (3) selecting, by the processing hardware, a procedure for communicating the first data based at least in part on whether the UE is performing early-data communication.

Example 2 is the method of example 1, wherein: the first data is downlink (DL) data received from the CN; and the selecting is further based on whether the DL data qualifies for early data transmission (EDT) to the UE.

Example 3 is the method of example 2, wherein the selecting includes: when the first data does not qualify for EDT, selecting a paging procedure, including transmitting to the UE a paging message.

Example 4 is the method of example 3, further including: receiving, by the processing hardware from the UE, a request to resume a radio connection between the UE and the RAN; and transmitting, by the processing hardware to the UE and in response to the request, a command to resume the radio connection.

Example 5 is the method of example 2, wherein the selecting includes: when the first data does not qualify for EDT, selecting a procedure for resuming a suspended radio connection between the UE and the RAN, including transmitting to the UE a command to resume the radio connection, including omitting a paging procedure.

Example 6 is the method of example 2, wherein the selecting includes: when the first data does not qualify for EDT, selecting a procedure for transmitting non-EDT data over a suspended radio connection, including transmitting to the UE a data packet that includes at least a portion of the DL data, while the UE continues to operate in the inactive state.

Example 7 is the method of example 6, further including: receiving, by the processing hardware from the UE and in response to the data packet, a request to resume a radio connection between the UE and the RAN; and transmitting, by the processing hardware to the UE and in response to the request, a command to resume the radio connection.

Example 8 is the method of example 6, further including: receiving, by the processing hardware from the UE and in response to the data packet, a message associated with the protocol for controlling radio resources and dedicated to requesting communication of non-EDT data; and transmitting, by the processing hardware to the UE and in response to the request, a command to resume the radio connection.

Example 9 is the method of example 2, wherein the selecting includes: when the first data does not qualify for EDT, selecting a procedure for notifying the UE of non-early DL data, including transmitting to the UE a message associated with the protocol for controlling radio resources, the message indicating arrival of the first data, while the UE continues to operate in the inactive state.

Example 10 is the method of example 9, further including: receiving, by the processing hardware from the UE and in response to the message, a request to resume a radio connection between the UE and the RAN; and transmitting, by the processing hardware to the UE and in response to the request, a command to resume the radio connection.

Example 11 is the method of any of the preceding examples implemented in a central unit (CU) of the base station including the CU and a distributed unit (DU).

Example 12 is the method of example 1 implemented in a CU of the base station including the CU and a DU, wherein: determining that the first data is available includes receiving, from the UE via the DU, an UL message associated with the protocol for controlling radio resources; and selecting the procedure is further based on the UL message.

Example 13 is the method of example 12, wherein the UL message is dedicated to requesting communication of non-EDT data.

Example 14 is the method of example 12, wherein the selecting includes: selecting, in a first instance, a UE context setup procedure in response to determining that the UL message was received over a common control channel (CCCH), and selecting, in a second instance, a UE context modification procedure in response to determining that the UL message was received over a dedicated control channel (DCCH).

Example 15 is the method of example 12, wherein the selecting includes: selecting, in a first instance, a UE context setup procedure in response to determining that the UL message is a request to resume a radio connection between the UE and the DU, and selecting, in a second instance, a UE context modification procedure in response to determining that the UL message is a message other than the request to resume the radio connection.

Example 16 is the method of example 1 implemented in a CU of the base station including the CU and a plurality of DUs, wherein selecting the procedure includes: in a first instance, in response to determining that the UE is performing early-data communication, sending a request to page the UE only to a DU via which the UE is performing early-data communication, and in a second instance, in response to determining that the UE is not performing early-data communication, sending a request to page the UE to each of the plurality of DUS.

Example 17 is a base station including processing hardware and configured to implement a method of any of examples 1-16.

Example 18 is a method implemented in a user equipment (UE) for communicating data with a core network (CN) via a radio access network (RAN). The method includes: (1) performing, by processing hardware and in an inactive state of a protocol associated with controlling radio resources, an early data communication with the CN; (2) determining, by the processing hardware and while the UE continues to operate in the inactive state, whether non-early data is available for communicating between the UE and the CN; and (3) when the non-early data is available, transitioning to a connected state of the protocol.

Example 19 is the method of example 18, further including: receiving, prior to the UE transitioning to the inactive state, a message indicating a radio bearer allocated for early data communication.

Example 20 is the method of example 19, wherein the message is a radio resource control (RRC) release indication.

Example 21 is the method of example 19, wherein the message is a downlink (DL) RRC reconfiguration command.

Example 22 is the method of example 18, wherein: the UE is configured with a plurality of radio bearers; the method further including: determining which of the plurality of radio bearers is configured for the early data communication based on a radio bearer type.

Example 23 is the method of any examples 18-22, wherein determining that the non-early data is available includes: receiving, by the processing hardware from the RAN and via a non-early data radio bearer, a DL data packet.

Example 24 is the method of example 23, further including: transmitting, by the processing hardware to the RAN, a UL data packet via the non-early data radio bearer.

Example 25 is the method of any examples 18-22, wherein determining that the non-early data is available includes: receiving, by the processing hardware from the RAN and via a signaling radio bearer, a message indicating that non-early DL data is available.

Example 26 is the method of any examples 18-25, further including: in response to determining that the non-early data is available, transmitting to the RAN a request to transition to the connected state.

Example 27 is the method of example 26, wherein transmitting the request includes transmitting a DCCH message.

Example 28 is the method of example 27, wherein the DCCH message is UE assistance information message.

Example 29 is the method of example 26, wherein transmitting the request includes transmitting a CCCH message.

Example 30 is the method of example 29, wherein the CCCH message is an RRC resume request.

Example 31 is the method of any examples 18-30, further including: in response to determining that the non-early data is available for communication in an uplink direction from the UE to the RAN, transmitting to the RAN a buffer state report (BSR).

Example 32 is the method of example 18, further including: determining, by the processing hardware, to transition to the connected state in response to determining that the non-early data is UL data associated with a non-early data radio bearer.

Example 33 is the method of example 18, further including: subsequently to transitioning to the connected state, communicating the non-early data using (i) a first radio bearer configured for early data communication and (ii) a second radio bearer configured for non-early data communication.

Example 34 is a method implemented in a user equipment (UE) for transitioning between states of a protocol for controlling radio resources between the UE and a radio access network (RAN). The method includes: (1) determining, by processing hardware, that the UE is to transition from an inactive state of the protocol to a connected state of the protocol; (2) determining, by the processing hardware, whether the UE is performing early data communication with a core network (CN) via the RAN; and (3) selecting, by the processing hardware and based on whether the UE is performing early data communication, an uplink (UL) message for transmission to the RAN, to transition the UE to the connected state.

Example 35 is the method of example 34, wherein the selecting includes: selecting a DCCH message.

Example 36 is the method of example 35, wherein the DCCH message is UE assistance information message.

Example 37 is the method of example 34, wherein the selecting includes: selecting a CCCH message.

Example 38 is the method of example 37, wherein the CCCH message is an RRC resume request.

Example 39 is a user equipment (UE) including processing hardware and configured to implement a method of any of examples 18-38.

The following description may be applied to the description above.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “early data communication” can be replaced by “small data communication” and “early data transmission” can be replaced by “small data transmission”. In some implementations, “communicating data via RB(s)” can be replaced by “communicate data associated to RB(s)” or “communicate data on RB(s)”. “communicate” can be replaced by “transmit”, “receive” or “transmit and receive”.

A user device in which the above-described methods can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may be software modules (e.g., code stored on non-transitory machine-readable medium) or hardware modules. A hardware module is a tangible unit capable of performing certain operations and may be configured or arranged in a certain manner. A hardware module can including dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the methods can be provided as part of the operating system, a library used by multiple applications, a particular software application, etc. The software can be executed by one or more general-purpose processors or one or more special-purpose processors.

What is claimed is:

1. A method implemented in a base station operating in a radio access network (RAN), for facilitating data communication between a UE and a core network (CN), the method comprising:
determining, by the base station, that first data is available for communicating between the CN and the UE operating in an inactive state of a protocol for controlling radio resources;
determining, by the base station, whether the UE is performing early-data communication of second data; and
selecting, by the base station, a procedure for communicating the first data based at least in part on whether the UE is performing early-data communication.

2. The method of claim 1, wherein:
the first data is downlink (DL) data received from the CN; and
the selecting is further based on whether the DL data qualifies for early data transmission (EDT) to the UE.

3. The method of claim 2, wherein the selecting includes:
when the first data does not qualify for EDT, selecting a paging procedure, including transmitting to the UE a paging message.

4. The method of claim 2, wherein the selecting includes:
when the first data does not qualify for EDT, selecting a procedure for resuming a suspended radio connection between the UE and the RAN, including transmitting to the UE a command to resume the radio connection, including omitting a paging procedure.

5. The method of claim 2, wherein the selecting includes:
when the first data does not qualify for EDT, selecting a procedure for transmitting non-EDT data over a suspended radio connection, including transmitting to the UE a data packet that includes at least a portion of the DL data, while the UE continues to operate in the inactive state.

6. The method of claim 2, wherein the selecting includes:
when the first data does not qualify for EDT, selecting a procedure for notifying the UE of non-early DL data, including transmitting to the UE a message associated with the protocol for controlling radio resources, the message indicating arrival of the first data, while the UE continues to operate in the inactive state.

7. The method of any of the preceding claims implemented in a central unit (CU) of the base station including the CU and a distributed unit (DU).

8. The method of claim 1 implemented in a CU of the base station including the CU and a DU, wherein:
determining that the first data is available includes receiving, from the UE via the DU, an UL message associated with the protocol for controlling radio resources; and
selecting the procedure is further based on the UL message.

9. The method of claim 8, wherein the selecting includes:
selecting, in a first instance, a UE context setup procedure in response to determining that the UL message was received over a common control channel (CCCH), and
selecting, in a second instance, a UE context modification procedure in response to determining that the UL message was received over a dedicated control channel (DCCH).

10. The method of claim 8, wherein the selecting includes:
selecting, in a first instance, a UE context setup procedure in response to determining that the UL message is a request to resume a radio connection between the UE and the DU, and
selecting, in a second instance, a UE context modification procedure in response to determining that the UL message is a message other than the request to resume the radio connection.

11. The method of claim 1 implemented in a CU of the base station including the CU and a plurality of DUs, wherein selecting the procedure includes:
in a first instance, in response to determining that the UE is performing early-data communication, sending a request to page the UE only to a DU via which the UE is performing early-data communication, and
in a second instance, in response to determining that the UE is not performing early-data communication, sending a request to page the UE to each of the plurality of DUs.

12. A base station comprising processing hardware and a transceiver, configured to implement a method of any of claims 1-11.

13. A method implemented in a user equipment (UE) for communicating data with a core network (CN) via a radio access network (RAN), the method comprising:
performing, by the UE and in an inactive state of a protocol associated with controlling radio resources, an early data communication with the CN;
determining, by the UE and while the UE continues to operate in the inactive state, whether non-early data is available for communicating between the UE and the CN; and
when the non-early data is available, transitioning to a connected state of the protocol.

14. The method of claim 13, wherein determining that the non-early data is available includes:
receiving, by the UE from the RAN and via a non-early data radio bearer, a DL data packet; or
receiving, by the UE from the RAN and via a signaling radio bearer, a messaging indicating that non-early DL data is available.

15. The method of claim 13 or 14, further comprising:
in response to determining that the non-early data is available, transmitting to the RAN a request to transition to the connected state.

16. The method of claim 15, wherein transmitting the request includes transmitting a DCCH message or a CCCH message.

17. The method of claim 13, further comprising:
determining, by the UE, to transition to the connected state in response to determining that the non-early data is UL data associated with a non-early data radio bearer.

18. The method of claim 13, further comprising:
subsequently to transitioning to the connected state, communicating the non-early data using (i) a first radio bearer configured for early data communication and (ii) a second radio bearer configured for non-early data communication.

19. A user equipment (UE) comprising processing hardware and a transceiver, configured to implement a method of any of claims 13-18.
